(19) United States
(12) Patent Application Publication
(10) Pub. No.: US 2024/0076964 A1
(43) Pub. Date: Mar. 7, 2024

(54) System, Method and Apparatus for Creating Electrolysis

(71) Applicant: Foret Plasma Labs, LLC, The Woodlands, TX (US)

(72) Inventor: Todd Foret, The Woodlands, TX (US)

(21) Appl. No.: 18/504,069

(22) Filed: Nov. 7, 2023

Related U.S. Application Data
(63) Continuation-in-part of application No. 16/254,573, filed on Jan. 22, 2019, now Pat. No. 11,806,686.
Application No. 16/254,573 is a continuation-in-part of application No. 15/480,468, filed on Apr. 6, 2017, now Pat. No. 10,184,322.
Application No. 15/480,468 is a continuation of application No. 14/704,538, filed on May 5, 2015, now Pat. No. 9,644,465.
Application No. 14/704,538 is a continuation of application No. 12/288,170, filed on Oct. 16, 2008, now Pat. No. 9,051,820.
(60) Provisional application No. 61/028,386, filed on Feb. 13, 2008.
(60) Provisional application No. 60/980,443, filed on Oct. 16, 2007.

(51) Int. Cl. E21B 43/08; C10B 23/00; C10B 53/06; C25B 1/00; C25B 9/19; C25B 9/65; C25B 11/03; C25B 13/02; C25B 13/08; E21B 36/00; E21B 36/04; E21B 43/17; E21B 43/24; E21B 43/243; H05H 1/48

(52) U.S. Cl. CPC E21B 43/082; C10B 23/00; C10B 53/06; C25B 1/00; C25B 9/19; C25B 9/65; C25B 11/03; C25B 13/02; C25B 13/08; E21B 36/008; E21B 36/04; E21B 43/08; E21B 43/17; E21B 43/2401; E21B 43/2405; E21B 43/243; H05H 1/48; H05H 1/471

(57) ABSTRACT

Electrolysis devices and systems include a first plate having first and second outlets; a first screen extending below the first plate proximate to the first outlet wherein a inner diameter of the first screen≥an inner diameter of the first outlet; a tube extending below the first plate wherein the tube is disposed around the first screen with a first gap between the first screen and the tube; a second screen extending below the first plate such that the second screen is disposed around the tube with a second gap between the tube and the second screen; the second outlet is either disposed between the tube and the second screen or outside of the second screen; and wherein a length of the first screen is less that a length of the second screen, and a length of the tube is greater than the length of the second screen.

### PRIORITY CLAIM AND CROSS-REFERENCE TO RELATED APPLICATIONS

This patent application is a continuation-in-part patent application of U.S. patent application Ser. No. 16/254,573 filed on Jan. 22, 2019 and entitled “System, Method and Apparatus for Creating an Electrical Glow Discharge”, now U.S. Pat. No. 11,806,686, which is a continuation-in-part patent application of U.S. patent application Ser. No. 15/480,468 filed on Apr. 6, 2017 and entitled “System, Method and Apparatus for Creating an Electrical Glow Discharge”, now U.S. Pat. No. 10,184,322, which is a continuation patent application of U.S. patent application Ser. No. 14/704,538 filed on May 5, 2015 and entitled “System, Method and Apparatus for Creating an Electrical Glow Discharge, now U.S. Pat. No. 9,644,465, which is a continuation patent application of U.S. patent application Ser. No. 12/288,170 filed on Oct. 16, 2008 and entitled “System, Method and Apparatus for Creating an Electrical Glow Discharge”, now U.S. Pat. No. 9,051,820, which is non-provisional patent application of: (1) U.S. provisional patent application 60/980,443 filed on Oct. 16, 2007 and entitled “System, Method and Apparatus for Carbonizing Oil Shale with Electrolysis Plasma Well Screen”; and (2) U.S. provisional patent application 61/028,386 filed on Feb. 13, 2008 and entitled “High Temperature Plasma Electrolysis Reactor Configured as an Evaporator, Filter, Heater or Torch.”

This patent application is related to PCT patent application PCT/US23/78254 filed on Oct. 30, 2023 and entitled “Wave Energy Systems.”

All of the foregoing applications are hereby incorporated by reference in their entirety.

### FIELD OF THE INVENTION

The present invention relates to the field of treating fluids using electrolysis.

### BACKGROUND OF THE INVENTION

There are many problems associated with the production of oil and gas resources. For example, it is very common for oil production wells to reach the end of their life, while there is still a substantial amount of oil in place (OIP) within the formation. Engineers may then to decide whether to shut in the well or stimulate the well using enhanced oil recovery (EOR) methods ranging from water flooding to steam flooding to injection of carbon dioxide and injection of solvents.

Likewise, even during peak production of a well, a well may have to be shut in due to paraffin plugging the production tubing. This can cause several problems ranging from reduced production to parting or breaking of the sucker rod connected to the surface pump jack.

Another problem associated with most oil and gas wells is produced water. When the water reaches the surface it is separated from the oil or gas and then must be treated prior to final disposition.

Recently, primarily due to high crude oil prices many exploration companies are turning to unconventional heavy oil resources (API<22) such as oil sand bitumen, oil shale kerogen as well as heavy oil itself. Canada contains the largest known oil sand reserves estimated at over 1 trillion recoverable barrels of bitumen. Likewise, the largest known unconventional petroleum or hydrocarbon resource can be found in the Green River Formation in Colorado, Wyoming and Utah. Worldwide oil shale reserves are estimated around 2.9-3.3 trillion barrels of shale oil while the Green River Formation reserves alone are estimated to contain between 1.5-2.6 trillion barrels.

However, emerging issues with respect to the renewed interest in oil shale development range from water resources, to green house gas emissions to basic infrastructure needs. Likewise, the Canadian oil sands has its own problems ranging from very large tailings ponds to a lack of upgrading capacity for the bitumen recovered from the oil sands. In addition, the steam assisted gravity drainage (SAGD) process utilizes copious amounts of energy to produce steam. Two problems associated with producing steam are first the source of water and removing its contaminants that may be deposited upon boiler tube walls and second recovering the latent heat within the steam when injected downhole.

Likewise, there are many proponents suggesting CO₂ injection as means for recovering heavy oil, oil sand and oil shale. As recently as Apr. 4, 2007 Schlumberger's scientific advisor on CO₂, T. S. (Rama) Ramakrishnan has stated, “The research for efficient heavy oil recovery is still wide open. Steam flooding is the tried and trusted method, but we need to move forward. Having said that, I do not think advances will come about by refining current practices or expanding an existing research pilot—we need a step-change vis-à-vis enhancing heavy oil recovery. Oil at $60/bbl should be enough to provide the impetus.”

Shell Oil Company has been demonstrating its freeze-wall and in situ conversion process (ICP) for recovering kerogen from the Green River Formation located in Colorado's Piceance Basin. Although Shell has patented various aspects of the process, two of the impediments to large volume production of oil shale using ICP are the type of downhole heater and the formation's constituents. U.S. Pat. No. 7,086,468 and the family of other patents and published patent applications based on U.S. Provisional Patent Application Nos. 60/199,213 (Apr. 24, 2000), 60/199,214 (Apr. 24, 2000) and 60/199,215 (Apr. 24, 2000) provide detailed descriptions of the various prior art aboveground and in situ methods of retorting oil shale, all of which are hereby incorporated by reference in their entirety. Moreover, updated information regarding aboveground and in situ methods of retorting oil shale in the Green River Formation are described in “Converting Green River oil shale to liquid fuels with Alberta Taciuk Processor: energy inputs and greenhouse gas emissions” by Adam R Brandt (Jun. 1, 2007) and “Converting Green River oil shale to liquid fuels with the Shell in-situ conversion process: energy inputs and greenhouse gas emissions” by Adam R Brandt (Jun. 30, 2007), both of which are available at http://abrandt.berkeley.edu/shale/shale.html and are hereby incorporated by reference in their entirety.

What is unique about the Green River Formation oil shale is that it has a high content of Nahcolite. Nahcolite is commonly referred to as baking soda which is sodium bicarbonate (NaHCO₃). Another active player in oil shale development, ExxonMobil, has developed an in situ conversion process for oil shale that is rich in Nahcolite. The process incorporates recovering kerogen while converting sodium bicarbonate or Nahcolite to sodium carbonate. ExxonMobil claims that the pyrolysis of the oil shale should enhance leaching and removal of sodium carbonate during solution mining.

Now, returning back to Shell's ICP for oil shale, the two largest problems to overcome are that baking soda can be used as a heating insulator and that oil shale is not very permeable. Thus using conventional heat transfer methods such as conduction and convection require a long period of time in addition to drilling many wells and incorporating many heaters close to one another.

Although in situ processes are rapidly developing for both oil shale and oil sands, surface processing is currently the leader for oil sands. Retorting of oil shale has been around since the early 1970's. Recently, retorting has been applied to oil sands. Once again the major problem with retorting either oil sand or oil shale is that the minerals and metals act to retard heat transfer. However, the single largest difference between oil shale and oil sand is that sodium carbonate is a known electrolyte. Likewise, oil sand contains electrolytes in the form of other salts.

While melting oil shale in a carbon crucible the inventor of the present invention has recently unexpectedly discovered a method for carbonizing oil shale with plasma electrolysis while simultaneously separating solids, liquids and gases. The process is based upon using the same mineral that is widespread in the Green River Formation—Baking Soda.

### SUMMARY OF THE INVENTION

One embodiment of the present invention provides an insertable plasma electrolysis apparatus comprising a first non-conductive plate having a first outlet and a second outlet; a first cylindrical conductive screen extending below the first non-conductive plate proximate to the first outlet such that a inner diameter of the first cylindrical conductive screen is greater than or equal to an inner diameter of the first outlet; a cylindrical non-conductive tube extending below the first non-conductive plate such that the cylindrical non-conductive tube is disposed around the first cylindrical conductive screen with a first substantially equidistant gap between the first cylindrical conductive screen and the cylindrical non-conductive tube; a second cylindrical conductive screen extending below the first non-conductive plate such that the second cylindrical conductive screen is disposed around the cylindrical non-conductive tube with a second substantially equidistant gap between the cylindrical non-conductive tube and the second cylindrical conductive screen; the second outlet is either disposed between the cylindrical non-conductive tube and the second cylindrical conductive screen or outside of the second cylindrical conductive screen; a first electrical terminal coupled to the first cylindrical conductive screen; a second electrical terminal coupled to the second cylindrical conductive screen; and wherein a length of the first cylindrical conductive screen is less that a length of the second cylindrical conductive screen, and a length of the cylindrical non-conductive tube is greater than the length of the second cylindrical conductive screen.

In one aspect, the apparatus is configured to be inserted into a vessel, pipe, conduit, column, tank, well or any structure that holds a fluid to form a closed system. In another aspect, the first cylindrical conductive screen comprises a cathode and the second cylindrical conductive screen comprises an anode. In another aspect, the first cylindrical conductive screen is substantially aligned with a longitudinal axis of the first outlet. In another aspect, the first outlet and the second outlet extend above a top of the first non-conductive plate. In another aspect, the first electrical terminal is connected to the first outlet, and the first outlet is electrically conductive and attached to the first cylindrical conductive screen, and the second electrical terminal is connected to the second outlet, and the second outlet is electrically conductive and attached to the second cylindrical conductive screen. In another aspect, a second non-conductive plate is attached above or below the first non-conductive plate. In another aspect, the first cylindrical conductive screen is attached to the second non-conductive plate. In another aspect, the cylindrical non-conductive tube is attached to the second non-conductive plate. In another aspect, the second cylindrical conductive screen is attached to the second non-conductive plate. In another aspect, the cylindrical non-conductive tube comprises a third cylindrical non-conductive tube, and further comprising: a first cylindrical non-conductive tube attached to a bottom of the first cylindrical conductive screen or an extension of the first cylindrical conductive screen that is coated with a non-conductive material; a second cylindrical non-conductive tube attached to a bottom of the second cylindrical screen or an extension of the second cylindrical conductive screen that is coated with the non-conductive material; and a third non-conductive plate attached to a bottom of the first cylindrical non-conductive tube or a bottom of the extension of the first cylindrical conductive screen, a bottom of the second cylindrical non-conductive tube or a bottom of the extension of the second cylindrical conductive screen, wherein a third gap is formed between the third non-conductive plate and a bottom of the third cylindrical non-conductive tube. In another aspect, an opening is disposed in the third non-conductive plate and connected to the first cylindrical tube. In another aspect, a non-conductive granular material is disposed partially or completely within the first substantially equidistant gap and the second substantially equidistant gap. In another aspect, the non-conductive granular material (a) does not pass through the first cylindrical conductive screen and the second cylindrical conductive screen, (b) allows an electrically conductive fluid to flow between the first cylindrical conductive screen and the second cylindrical conductive screen, and (c) prevents electrical arcing between the first and second cylindrical conductive. In another aspect, the non-conductive granular material comprises marbles, ceramic beads, molecular sieve media, sand, limestone, activated carbon, zeolite, zirconium, alumina, rock salt, nut shell or wood chips.

Another embodiment of the present invention provides a plasma electrolysis apparatus comprising: a vessel; a first non-conductive plate having a first outlet and a second outlet, wherein the first non-conductive plate is attached to a top of the vessel; a first cylindrical conductive screen extending below the first non-conductive plate proximate to the first outlet such that a inner diameter of the first cylindrical conductive screen is greater than or equal to an inner diameter of the first outlet; a cylindrical non-conductive tube extending below the first non-conductive plate such that the cylindrical non-conductive tube is disposed around the first cylindrical conductive screen with a first substantially equidistant gap between the first cylindrical conductive screen and the cylindrical non-conductive tube; a second cylindrical conductive screen extending below the first non-conductive plate such that the second cylindrical conductive screen is disposed around the cylindrical non-conductive tube with a second substantially equidistant gap between the cylindrical non-conductive tube and the second cylindrical conductive screen; the second outlet is either disposed between the cylindrical non-conductive tube and the second cylindrical conductive screen or outside of the second cylindrical conductive screen; a first electrical terminal coupled to the first cylindrical conductive screen; a second electrical terminal coupled to the second cylindrical conductive screen; wherein a length of the first cylindrical conductive screen is less that a length of the second cylindrical conductive screen, and a length of the cylindrical non-conductive tube is greater than the length of the second cylindrical conductive screen; a non-conductive granular material disposed partially or completely within vessel, the first substantially equidistant gap, and the second substantially equidistant gap; a first vessel inlet or outlet disposed in a side of the vessel; a second vessel inlet or outlet disposed in a bottom of the vessel or the side of the vessel proximate to the bottom of the vessel; and one or more screens or filters disposed within or proximate to the first vessel inlet or outlet and the second vessel inlet or outlet, wherein the non-conductive granular material does not pass through the one or more screens or filters.

In one aspect, an electrically conductive fluid is disposed within the vessel. In another aspect, the electrically conductive fluid comprises water, produced water, wastewater or tailings pond water. In another aspect, the electrically conductive fluid comprises a fluid containing an electrolyte. In another aspect, the electrolyte comprises baking soda, Nahcolite, lime, sodium chloride, ammonium sulfate, sodium sulfate or carbonic acid. In another aspect, an electrolysis is created whenever the first electrical terminal is connected to an electrical power supply such that the first electrically conductive screen has a first polarity, the second electrical terminal is connected to the electrical power supply such that the second electrically conductive screen has a second polarity, and the electrically conductive fluid is introduced into the first and second substantially equidistant gaps. In another aspect, hydrogen exits the first outlet and an oxidant outlet exits the second outlet. In another aspect, the first electrically conductive screen or the second electrically conductive screen reaches a temperature of at least 500° C., 1000° C., or 2000° C. during the electrolysis. In another aspect, once the electrolysis is created, the electrolysis is maintained without the electrically conductive fluid. In another aspect, the vessel comprises a pipe, conduit, column, tank, well or any structure that holds a fluid to form a closed system. In another aspect, a power supply is electrically coupled to the first cylindrical conductive screen and the second cylindrical conductive screen. In another aspect, the electrical power supply operates in a range from 50 to 500 volts DC, or 200 to 400 volts DC. In another aspect, first cylindrical conductive screen comprises a cathode and the second cylindrical conductive screen comprises and anode. In another aspect, one or more sensors monitor one or more parameters within the vessel. In another aspect, the apparatus includes an eductor having a first inlet, a second inlet and an outlet, wherein the outlet is coupled to the second vessel inlet or outlet; a pump coupled to the first inlet of the eductor; and a control valve coupled to the second inlet of the eductor. In another aspect, an electrically conductive tube having a porous tip is disposed within the first outlet and extending into the vessel beyond the length of the first cylindrical conductive screen. In another aspect, an electrolysis is created whenever the electrically conductive tube is connected to an electrical power supply such that the electrically conductive tube has a first polarity, the second electrical terminal is connected to the electrical power supply such that the second electrically conductive screen has a second polarity, and an electrically conductive fluid is introduced into the first and second substantially equidistant gaps; and carbon monoxide exits the first output when carbon dioxide is introduced into the electrically conductive tube.

Another embodiment of the present invention provides a method for creating electrolysis comprising: providing a plasma electrolysis apparatus comprising: a vessel, a first non-conductive plate having a first outlet and a second outlet, wherein the first non-conductive plate is attached to a top of the vessel, a first cylindrical conductive screen extending below the first non-conductive plate proximate to the first outlet such that a inner diameter of the first cylindrical conductive screen is greater than or equal to an inner diameter of the first outlet, a cylindrical non-conductive tube extending below the first non-conductive plate such that the cylindrical non-conductive tube is disposed around the first cylindrical conductive screen with a first substantially equidistant gap between the first cylindrical conductive screen and the cylindrical non-conductive tube, a second cylindrical conductive screen extending below the first non-conductive plate such that the second cylindrical conductive screen is disposed around the cylindrical non-conductive tube with a second substantially equidistant gap between the cylindrical non-conductive tube and the second cylindrical conductive screen, the second outlet is either disposed between the cylindrical non-conductive tube and the second cylindrical conductive screen or outside of the second cylindrical conductive screen, a first electrical terminal coupled to the first cylindrical conductive screen, a second electrical terminal coupled to the second cylindrical conductive screen, wherein a length of the first cylindrical conductive screen is less that a length of the second cylindrical conductive screen, and a length of the cylindrical non-conductive tube is greater than the length of the second cylindrical conductive screen; a non-conductive granular material disposed partially or completely within vessel, the first substantially equidistant gap, and the second substantially equidistant gap, a first vessel inlet or outlet disposed in a side of the vessel, a second vessel inlet or outlet disposed in a bottom of the vessel or the side of the vessel proximate to the bottom of the vessel, and one or more screens or filters disposed within or proximate to the first vessel inlet or outlet and the second vessel inlet or outlet, wherein the non-conductive granular material does not pass through the one or more screens or filters; connecting the first and second electrical terminals to an electrical power supply such that the first electrically conductive screen has a first polarity, and the second electrically conductive screen has a second polarity; and creating the electrolysis by introducing an electrically conductive fluid into the first and second substantially equidistant gaps.

In one aspect, the electrically conductive fluid comprises water, produced water, wastewater or tailings pond water. In another aspect, the electrically conductive fluid comprises a fluid containing an electrolyte. In another aspect, the electrolyte comprises baking soda, Nahcolite, lime, sodium chloride, ammonium sulfate, sodium sulfate or carbonic acid. In another aspect, hydrogen exits the first outlet and an oxidant outlet exits the second outlet. In another aspect, the first electrically conductive screen or the second electrically conductive screen reaches a temperature of at least 500° C., 1000° C., or 2000° C. during the electrolysis. In another aspect, once the electrolysis is created, the electrolysis is maintained without the electrically conductive fluid. In another aspect, the vessel comprises a pipe, conduit, column, tank, well or any structure that holds a fluid to form a closed system. In another aspect, the electrical power supply operates in a range from 50 to 500 volts DC, or 200 to 400 volts DC. In another aspect, the first cylindrical conductive screen comprises a cathode and the second cylindrical conductive screen comprises and anode. In another aspect, one or more sensors monitor one or more parameters within the vessel. In another aspect, the apparatus includes an eductor having a first inlet, a second inlet and an outlet, wherein the outlet is coupled to the second vessel inlet or outlet; a pump coupled to the first inlet of the eductor; and a control valve coupled to the second inlet of the eductor. In another aspect, an electrically conductive tube having a porous tip is disposed within the first outlet and extends into the vessel beyond the length of the first cylindrical conductive screen. In another aspect, the method includes producing carbon monoxide from the first output by introducing carbon dioxide into the electrically conductive tube.

Various embodiments of the present invention are described in detail below with reference to the accompanying drawings.

### BRIEF DESCRIPTION OF THE DRAWINGS

The above and further advantages of the invention may be better understood by referring to the following description in conjunction with the accompanying drawings, in which:

FIG. 1 is a cross-sectional view of the ARCWHIRL™ Melter Crucible in accordance with on embodiment of the present invention;

FIG. 2 is a cross-sectional view of the ARCWHIRL™ Melter Crucible carbonizing oil shale with plasma electrolysis in accordance with on embodiment of the present invention;

FIG. 3 is a cross-sectional view of a preferred embodiment of the invention showing a plasma electrolysis well screen in accordance with on embodiment of the present invention;

FIG. 4 is cross-sectional view of a HI-TEMPER™ Filter with non-conductive media in accordance with on embodiment of the present invention;

FIG. 5 is a cross-sectional view of a preferred embodiment of the invention showing a toe to heal Oil Shale Carbonizing with Plasma Electrolysis in accordance with on embodiment of the present invention;

FIG. 6 is a cross-sectional view of a preferred embodiment of the invention showing horizontal wells for In Situ Oil Shale Carbonizing with Plasma Electrolysis in accordance with on embodiment of the present invention;

FIG. 7 is a cross-sectional view of a Insitu PAGD™ with ARCWHIRL™ in accordance with on embodiment of the present invention;

FIG. 8 is a cross-sectional view of a HI-TEMPER™ Well Screen Heater Treater in accordance with on embodiment of the present invention;

FIG. 9 is a cross-sectional view of a PLASMA ELECTROLYSIS INLINE FLANGE SCREEN™ in accordance with on embodiment of the present invention;

FIG. 10 is a cross-sectional view of a PLASMA ELECTROLYSIS STRIPPER COLUMN™ in accordance with on embodiment of the present invention;

FIG. 11 is a cross-sectional view of a SURFACE AND SUBSEA PLASMA ELECTROLYSIS METHANE HYDRATE BUSTER™ in accordance with on embodiment of the present invention;

FIG. 12 is a cross-sectional view of a Plasma Electrolysis Well Screen™ or Filter Screen in accordance with on embodiment of the present invention;

FIG. 13A depicts an insertable plasma electrolysis assembly in accordance with one embodiment of the present invention;

FIG. 31B depicts an exploded view of the positional relationship of the first cylindrical conductive screen, the cylindrical non-conductive tube and the second cylindrical conductive screen of FIG. 13A.

FIG. 14, depicts an insertable plasma electrolysis assembly in accordance with another embodiment of the present invention;

FIGS. 15A and 15B depict systems for creating electrolysis in accordance with various embodiments of the present invention;

FIG. 16 depicts an apparatus creating electrolysis in accordance with one embodiment of the present invention;

FIG. 17 depicts a method for creating electrolysis in accordance with another embodiment of the present invention;

FIG. 18 depicts a high temperature and high-pressure plasma electrolyzer in accordance with one embodiment of the present invention;

FIGS. 19, 20 and 21 depict a multiple mode electrolysis filter apparatus for treating fluent matter in accordance with various embodiments of the present invention;

FIG. 22 depicts a two plasma electrolysis wafer style screen columns or reactors used to produce hydrogen in accordance with one embodiment of the present invention;

FIG. 23 depicts a Virtual Inertia Plasma ElectrolyzeR Riser System in accordance with one embodiment of the present invention;

FIGS. 24 and 25 depict an Offshore Wind Energy Virtual Inertia Plasma ElectrolyzeR Riser System in accordance with various embodiments of the present invention;

FIGS. 26, 27, 28, 29, 30, 31 and 32 depict a Virtual Inertia Plasma ElectrolyzeR Riser System in accordance with various embodiments of the present invention;

FIG. 33 depicts screens of different diameters in accordance with one embodiment of the present invention;

FIGS. 34A and 34B depict a virtual inertia plasma electrolyzer in accordance with various embodiments of the present invention;

FIGS. 35A, 35B, 35C depict a virtual inertia plasma electrolyzer torch apparatus in accordance with various embodiments of the present invention;

FIGS. 36 and 37 depict a virtual inertia plasma electrolysis apparatus in accordance with various embodiments of the present invention;

FIGS. 38A, 38B and 37C disclose systems for retrofitting a hydrocyclone into a plasma electrolysis hydrocyclone in accordance with various embodiments of the present invention; and

FIG. 39 depicts a dual plasma electrolysis hydrocyclone system for making hydrogen and oxidants in accordance with one embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

It will be understood that the terms plasma electrolysis, glow discharge, glow discharge plasma and electrochemical plasma will be used interchangeably throughout this disclosure. Likewise, it will be understood that plasma electrolysis is substantially different and clearly differentiated within the art from traditional electrolysis or simple electrochemical reactions commonly referred to as REDOX (reduction oxidation) reactions. In plasma electrolysis a “plasma” is formed and maintained around the cathode which is surrounded by an electrolyte thus allowing for high temperature reactions such as gasification, cracking, thermolysis and pyrolysis to occur at or near the plasma interface. The circuit is thus completed from the cathode through the plasma and into the bulk liquid.

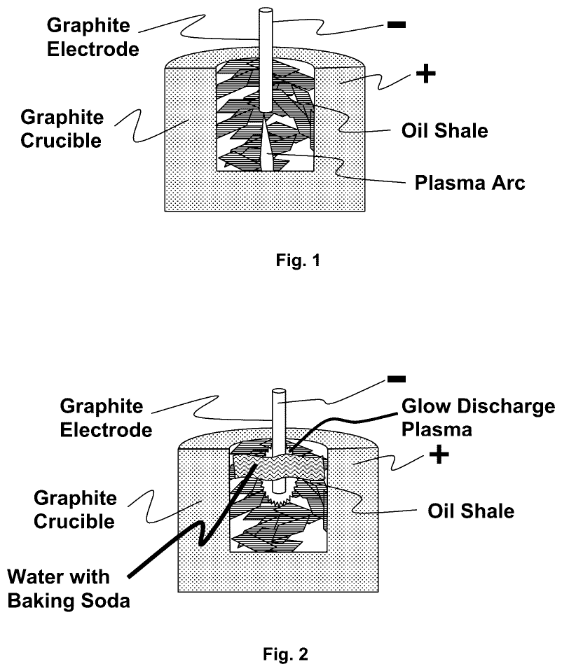

Turning now to FIG. 1, the inventor of the present invention melted a virgin sample of oil shale utilizing a carbon crucible operated in a plasma arc melting mode. Later and being very familiar with plasma electrolysis or glow discharge plasma, specifically using baking soda as the electrolyte, the inventor of the present invention, filled the same crucible with oil shale then mixed baking soda into water then filled the crucible with water as shown in FIG. 2.

The DC power supply was operated at 300 volts DC in order to get the electrically conductive water and baking soda solution (an ionic liquid or electrolyte) to arc over and form a glow discharge irradiating from the negative (−) graphite electrode. Within seconds the glow discharge, also commonly referred to as electrochemical plasma or plasma electrolysis was formed around the negative (−) cathode graphite electrode.

The plasma electrolysis cell was operated for one minute. The cathode was extracted from the cell and the carbon was glowing orange hot. The estimated surface temperature on the carbon cathode ranged from 1,000° C. to over 2,000° C. The color of the glow discharge plasma was orange. This is very typical of the emission spectra of a high pressure sodium lamp commonly found in street lights. Hence the use of baking soda, sodium hydrogen carbonate, which caused the orange plasma glow discharge.

The cell was shut down and allowed to cool. Immediately upon removing a piece of oil shale from the crucible a noticeable color change occurred on the outside of the normally grey oil shale. The shale was completely black. All the pieces of shale were covered in a black coke like substance. What occurred next was completely unexpected after crushing a piece of plasma electrolysis treated oil shale. The shale was internally carbonized up to ½ inch from the surface.

This simple procedure opens the door to a new process for enhanced recovery of unconventional fossil fuels such as heavy oil, oil sands and oil shale. Referring again to FIG. 2—Carbonizing Oil Shale with Plasma Electrolysis—the present invention can be applied to surface processing of oil shale or spent oil shale. Any retort can be retrofitted to operate in a plasma electrolysis mode. However, rotary washing screens commonly found in the mining industry as well as the agriculture industry can be retrofitted to operate in a continuous feed plasma electrolysis mode. The method of the present invention can be applied to oil sand also. This is a dramatic departure from traditional high temperature “DRY” retorting methods commonly applied within the oil shale industry. However, the plasma electrolysis method can be applied to the froth flotation step commonly employed within the oil sands industry. For the sake of simplicity, the remainder of this disclosure will provide a detailed explanation of the invention as applied to the carbonization of oil shale with plasma electrolysis.

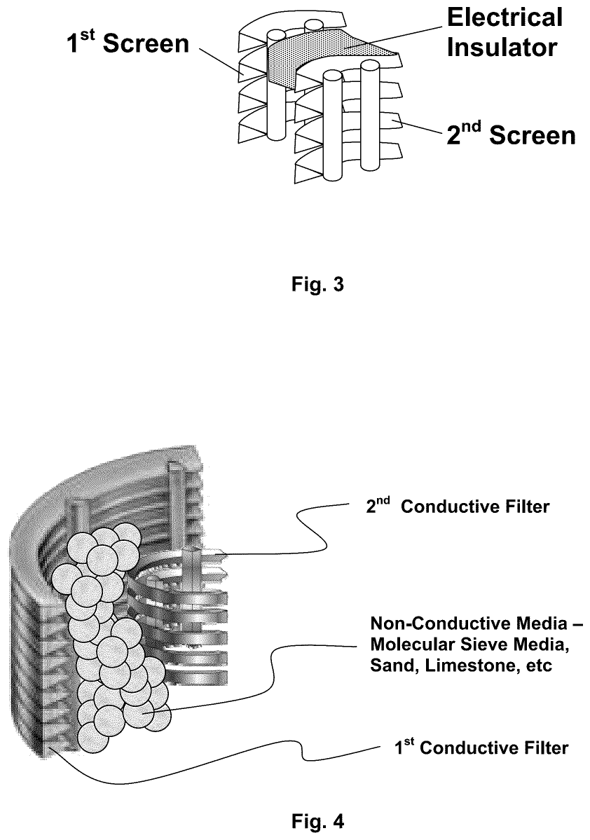

As shown in FIGS. 3 and 4, the present invention provides an apparatus for creating an electric glow discharge that includes a first electrically conductive screen, a second electrically conductive screen, one or more insulators attached to the first electrically conductive screen and the second electrically conductive screen, a non-conductive granular material disposed within the gap, a first electrical terminal electrically connected to the first electrically conductive screen, and a second electrical terminal electrically connected to the second electrically conductive screen. The insulator(s) maintain a substantially equidistant gap between the first electrically conductive screen and the second electrically conductive screen. The non-conductive granular material (a) does not pass through either electrically conductive screen, (b) allows an electrically conductive fluid to flow between the first electrically conductive screen and the second electrically conductive screen, and (c) prevents electrical arcing between the electrically conductive screens during the electric glow discharge. The electric glow discharge is created whenever: (a) the first electrical terminal is connected to an electrical power source such that the first electrically conductive screen is a cathode, the second electrical terminal is connected to the electrical power supply such that the second electrically conductive screen is an anode, and the electrically conductive fluid is introduced into the gap, or (b) the first electrical terminal and the second electrical terminal are both connected to the electrical power supply such that both electrically conductive screens are the cathode, and the electrically conductive fluid is introduced between both electrically conductive screens and an external anode connected to the electrical power supply.

The non-conductive granular material may include marbles, ceramic beads, molecular sieve media, sand, limestone, activated carbon, zeolite, zirconium, alumina, rock salt, nut shell or wood chips. The electrically conductive screens can be flat, tubular, elliptical, conical or curved. The apparatus can be installed within a conduit, pipeline, flow line, stripper column, reactor, a well or a well screen. In addition, the apparatus can be protected by a non-conductive rotating sleeve or a non-conductive screen. The electrical power supply can operate in a range from (a) 50 to 500 volts DC, or (b) 200 to 400 volts DC. The cathode can reach a temperature of (a) at least 500° C., (b) at least 1000° C., or (c) at least 2000° C. during the electric glow discharge. Note that once the electric glow discharge is created, the electric glow discharge is maintained without the electrically conductive fluid. The electrically conductive fluid can be water, produced water, wastewater or tailings pond water. An electrolyte, such as baking soda, Nahcolite, lime, sodium chloride, ammonium sulfate, sodium sulfate or carbonic acid, can be added to the electrically conductive fluid. The apparatus can be used as to heat or fracture a subterranean formation containing bitumen, kerogen or petroleum. The subterranean formation may contain oil shale or oil sand.

In addition, the present invention provides a method for creating an electric glow discharge by providing an electric glow apparatus, introducing an electrically conductive fluid into the gap, and connecting the electrical terminals to an electrical power supply such that the first electrically conductive screen is a cathode and the second electrically conductive screen is an anode. The electric glow discharge apparatus includes a first electrically conductive screen, a second electrically conductive screen, one or more insulators attached to the first electrically conductive screen and the second electrically conductive screen, a non-conductive granular material disposed within the gap, a first electrical terminal electrically connected to the first electrically conductive screen, and a second electrical terminal electrically connected to the second electrically conductive screen. The insulator(s) maintain a substantially equidistant gap between the first electrically conductive screen and the second electrically conductive screen. The non-conductive granular material (a) does not pass through either electrically conductive screen, (b) allows an electrically conductive fluid to flow between the first electrically conductive screen and the second electrically conductive screen, and (c) prevents electrical arcing between the electrically conductive screens during the electric glow discharge. The electric glow discharge is created whenever: (a) the first electrical terminal is connected to an electrical power source such that the first electrically conductive screen is a cathode, the second electrical terminal is connected to the electrical power supply such that the second electrically conductive screen is an anode, and the electrically conductive fluid is introduced into the gap, or (b) the first electrical terminal and the second electrical terminal are both connected to the electrical power supply such that both electrically conductive screens are the cathode, and the electrically conductive fluid is introduced between both electrically conductive screens and an external anode connected to the electrical power supply.

Moreover, the present invention provides a method for creating an electric glow discharge by providing an electric glow apparatus, introducing an electrically conductive fluid into the gap, connecting the electrical terminals to an electrical power supply such that the both electrically conductive screens are the cathode and the second electrically conductive screen is an anode, and connecting an external anode to the electrical power supply. The electric glow discharge apparatus includes a first electrically conductive screen, a second electrically conductive screen, one or more insulators attached to the first electrically conductive screen and the second electrically conductive screen, a non-conductive granular material disposed within the gap, a first electrical terminal electrically connected to the first electrically conductive screen, and a second electrical terminal electrically connected to the second electrically conductive screen. The insulator(s) maintain a substantially equidistant gap between the first electrically conductive screen and the second electrically conductive screen. The non-conductive granular material (a) does not pass through either electrically conductive screen, (b) allows an electrically conductive fluid to flow between the first electrically conductive screen and the second electrically conductive screen, and (c) prevents electrical arcing between the electrically conductive screens during the electric glow discharge. The electric glow discharge is created whenever: (a) the first electrical terminal is connected to an electrical power source such that the first electrically conductive screen is a cathode, the second electrical terminal is connected to the electrical power supply such that the second electrically conductive screen is an anode, and the electrically conductive fluid is introduced into the gap, or (b) the first electrical terminal and the second electrical terminal are both connected to the electrical power supply such that both electrically conductive screens are the cathode, and the electrically conductive fluid is introduced between both electrically conductive screens and an external anode connected to the electrical power supply.

The present invention also provides a system for creating an electric glow discharge that includes a power supply, a first electrically conductive screen, a second electrically conductive screen, one or more insulators attached to the first electrically conductive screen and the second electrically conductive screen, a non-conductive granular material disposed within the gap, a first electrical terminal electrically connected to the first electrically conductive screen, and a second electrical terminal electrically connected to the second electrically conductive screen. The insulator(s) maintain a substantially equidistant gap between the first electrically conductive screen and the second electrically conductive screen. The non-conductive granular material (a) does not pass through either electrically conductive screen, (b) allows an electrically conductive fluid to flow between the first electrically conductive screen and the second electrically conductive screen, and (c) prevents electrical arcing between the electrically conductive screens during the electric glow discharge. The electric glow discharge is created whenever: (a) the first electrical terminal is connected to an electrical power source such that the first electrically conductive screen is a cathode, the second electrical terminal is connected to the electrical power supply such that the second electrically conductive screen is an anode, and the electrically conductive fluid is introduced into the gap, or (b) the first electrical terminal and the second electrical terminal are both connected to the electrical power supply such that both electrically conductive screens are the cathode, and the electrically conductive fluid is introduced between both electrically conductive screens and an external anode connected to the electrical power supply.

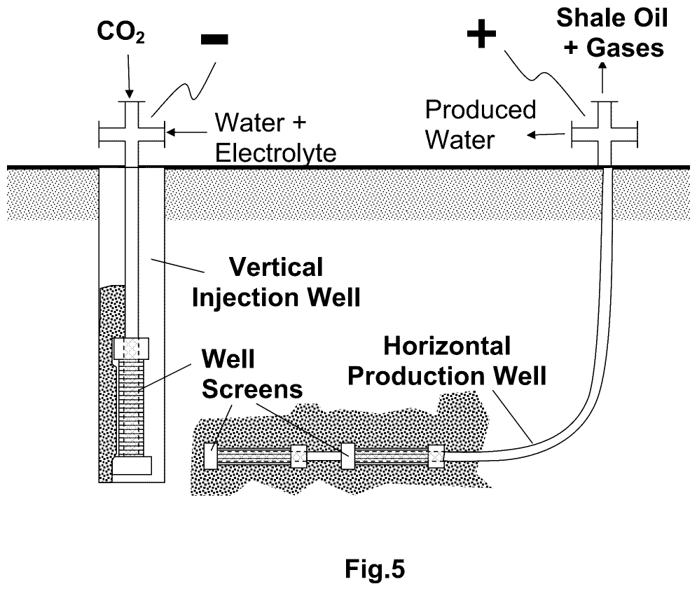

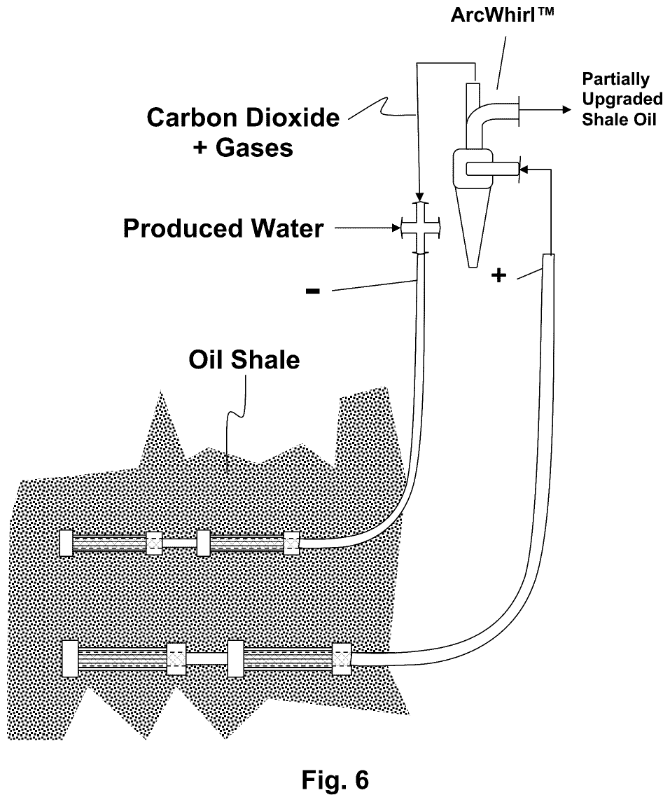

Turning now to FIG. 5—Toe to Heal Oil Shale Plasma Electrolysis, the conventional Enhanced Oil Recovery (EOR) with carbon dioxide (CO₂) method can be dramatically improved and is virtually a step-change from traditional CO₂ flooding. For example, the vertical injection well may be utilized as the cathode (−) while the horizontal production well may be utilized as the anode (+). On the surface a water source, for example, produced water, wastewater or tailings pond water is tested for conductivity in order to operate in a plasma electrolysis mode at a DC voltage ranging from 50 to 500 volts DC and more specifically between 200 and 400 volts DC. The conductivity may be increased by adding an electrolyte selected from Nahcolite (baking soda commonly found within oil shale formations), lime, sodium chloride, ammonium sulfate, sodium sulfate or carbonic acid formed from dissolving CO₂ into water.

In order to complete the electrical circuit between the vertical injection well and the horizontal production well, the horizontal well may be drilled such that a continuous bore is formed between both the vertical and horizontal wells. This is common for running a pipeline underneath a river or underneath a road. Whether the vertical well or horizontal well is utilized as the cathode an important and necessary disclosure is that the surface area for the cathode must be maximized in order to carry a sufficient current through the electrolyte which of course completes the electrical circuit.

There are many ways to maximize surface area, however the inventor of the present invention will disclose the best mode for maximizing cathode surface area. The graphite electrode as shown in FIG. 2 was replaced with a v-shaped wire screen which is commonly used as a well screen to prevent sand entrainment. The large surface area of the v-shaped wire screen immediately formed a large glow discharge when submersed into the carbon crucible with water and baking soda.

This disclosure is unique and unobvious in that it allows every oil and gas well, worldwide, to be converted into an in situ upgrader or heater treater. Referring to FIG. 3, a 1st well screen is separated from a 2nd well screen via an electrical insulator. The electrical insulator may be selected from a high temperature non-electrical conductive material such alumina or zirconia or any ceramic or composite material capable of withstanding temperatures greater than 500° C. Either the 1st or 2nd screen can be the cathode. Of course the other screen would be operated as the anode. In order to operate as an enhanced oil recovery (EOR) system, the only requirement is that the oil or gas must have a sufficient amount of conductivity. And of course most oil and gas wells produce water, hence the term produced water which is a highly conductive solution. The ionic produced water forms the glow discharge upon the cathode. Heavy paraffin wax contained in heavy oil will be upgraded or cracked into smaller molecules. This provides two beneficial attributes. First, since the paraffin waxes are no longer available to plug the well, hot oil injection may be reduced or completely eliminated. Second, since the heavy paraffin waxy hydrocarbons are what make a crude oil heavy, low API, cracking the waxes in situ, may lead to in situ upgrading. The higher the API gravity the easier it is to pump. Likewise, a high API gravity crude brings in a higher price.

In addition, it is well known that plasma electrolysis will produce hydrogen. Not being bound by theory, it is believed that bound sulfur species within crude oil may be converted to hydrogen sulfide when flowed through the PLASMA ELECTROLYSIS WELL SCREEN™. The H₂S can easily be separated from the crude oil with surface separation equipment.

The PLASMA ELECTROLYSIS WELL SCREEN™ can be utilized to fracture wells. For example, since electrolysis generates gases and plasma dramatically increases the temperature of the fluid, the production string simply needs to be filled with an electrolyte. Next, the well head can be shut in. When the DC power supply is energized, a glow discharge will be formed on the cathode. This will increase the pressure and temperature of the fluid while generating gases. The pressure will be released as the formation is fractured, thus more electrolyte may be added to the production string. This process may be very applicable to fracturing horizontal wells as shown in FIG. 5.

Referring to FIG. 5—Horizontal Wells for In Situ Oil Shale Carbonizing with Plasma Electrolysis, the aforementioned well fracturing method can be utilized by installing the PLASMA ELECTROLYSIS WELL SCREEN™ or GLOW DISCHARGE WELL SCREEN™ in both the upper and lower horizontal legs. To fracture the oil shale formation both wells are operated in independent plasma electrolysis modes in order to fracture the formation. Once the oil shale formation is fractured and an electrical circuit can be completed with an electrolyte between the upper and lower leg, then one well can be operated as the cathode while the other leg can be operated as the anode.

The oil shale will be carbonized in situ, thus allowing only light hydrocarbons and hydrogen to be produced with the electrolyte. Of course, it will be understood that the electrolyte may be recirculated to minimize water usage. Upon reaching the surface the produced water and shale oil may be further treated and separated with an invention of the present inventor's referred to as the ARCWHIRL™. Not being bound by theory, this process enables carbon sequestration to become a true reality by carbonizing the oil shale, thus minimizing the production of hydrocarbons while maximizing the production of hydrogen. Also, this process enables the hydrogen economy to become a reality utilizing the largest known fossil fuel reserves in the world—oil shale—while allowing the United States to become independent from foreign oil imports.

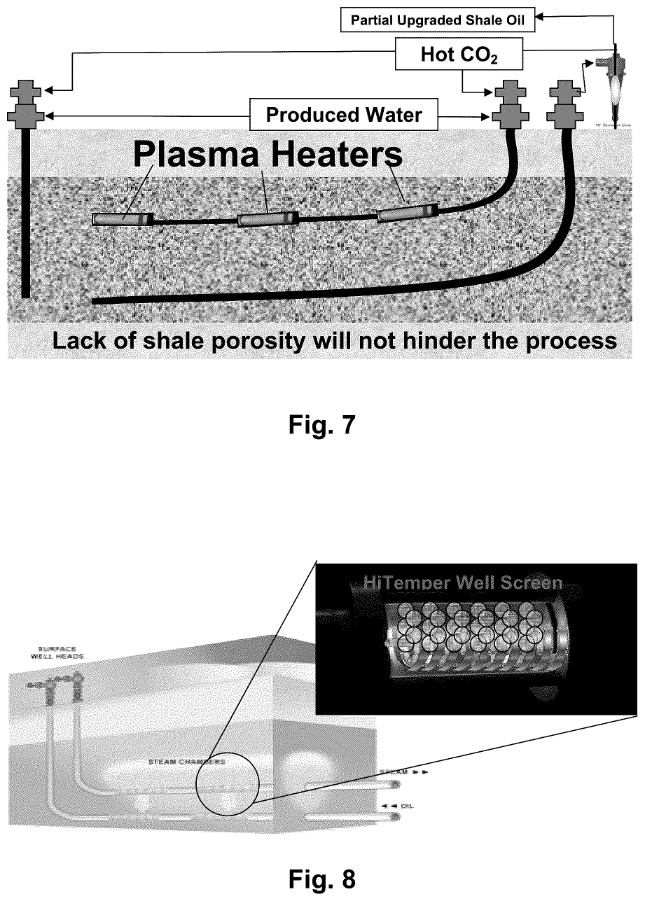

Different embodiments of the invention described above are also illustrated in the FIGS. 7-12.

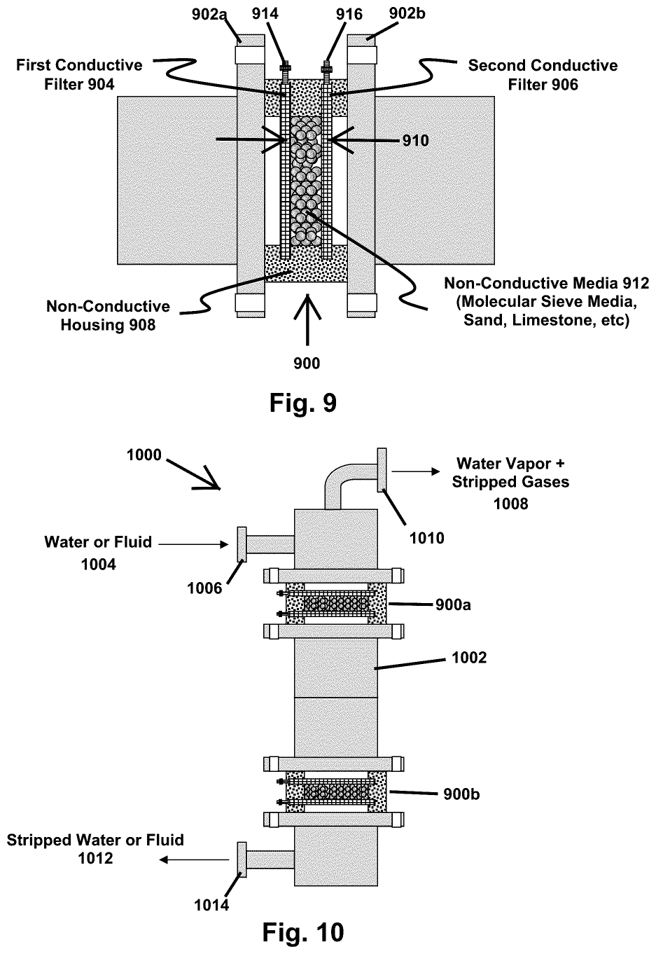

FIG. 9 is a cross-sectional view of a PLASMA ELECTROLYSIS INLINE FLANGE SCREEN™ or Electric Glow Discharge (EGD) assembly 900 in accordance with on embodiment of the present invention. The Electric Glow Discharge (EGD) assembly 900 can be easily installed by sandwiching the EGD assembly 900 between two commonly available flanges or connections 902a and 902b found on fluid transfer devices, such as tanks, vessels, stripper columns, reactors, pipes, or conduits, etc. The EGD assembly 900 includes a first conductive filter screen 904 and a second conductive filter screen 906 attached to a non-conductive housing 908, such as a non-conductive pipe or conduit. The first and second conductive filter screens 904 and 906 can be attached, affixed, potted, cast, molded, integrated or otherwise secured to the non-conductive housing 908. The first and second conductive filter screens 904 and 906 will generally have a relatively flat or planar cross section, and a shape that allows maximum fluid flow between the flanges or connections 902a and 902b (e.g., round shape for pipes and conduits). The equidistant gap 910 between the filter screens 904 and 906 is filled non-conductive granular material 912, such as marbles, ceramic beads, molecular sieve media, sand, limestone, activated carbon, zeolite, zirconium, alumina, rock salt, nut shell, wood chips, etc. The EGD assembly 900 is then sandwiched between the two flanges or connections 902a and 902b. A power supply (not shown) is connected to power supply leads 914 and 916, which are connected to the first filter screen 904 and second filter screen 906, respectively, such that one filter becomes a cathode and the other filter becomes an anode. When the power is turned on and an electrolyte flows through the EGD assembly 900, and an electric glow discharge is formed that treats the fluids flowing through the EGD wafer assembly 900.

Alternatively, the EGD assembly 900 could be integrated into the fluid transfer device, as long as the first conductive filter screen 904 and the second conductive filter screen 906 are electrically isolated from each other and any electrically conductive components. Moreover, the EGD assembly 900 can be equipped with one or more sensors communicably coupled to a control or monitoring unit/system. In some embodiments, the first and second conductive filter screens 904 and 906 along with the non-conductive granular material 912 can be removed without removing the entire EGD assembly 900.

Accordingly, the apparatus for creating an electric glow discharge comprises: a non-conductive housing having a longitudinal axis, a first opening aligned with the longitudinal axis, and a second opening aligned with the longitudinal axis and opposite the first opening; a first electrically conductive screen disposed proximate to the first opening of the housing and substantially perpendicular to the longitudinal axis; a second electrically conductive screen disposed proximate to the second opening of the housing and substantially perpendicular to the longitudinal axis, wherein the second electrically conductive screen separated from the first electrically conductive screen by a substantially equidistant gap; a non-conductive granular material disposed within the substantially equidistant gap; a first electrical terminal electrically connected to the first electrically conductive screen and disposed on an exterior of the housing; a second electrical terminal electrically connected to the second electrically conductive screen and disposed on an exterior of the housing; and wherein the electric glow discharge is created whenever the first electrical terminal is connected to an electrical power supply such that the first electrically conductive screen has a first polarity, the second electrical terminal is connected to the electrical power supply such that the second electrically conductive screen has a second polarity, and an electrically conductive fluid is introduced into the substantially equidistant gap.

In one aspect, the non-conductive granular material (a) does not pass through either electrically conductive screen, (b) allows the electrically conductive fluid to flow between the first electrically conductive screen and the second electrically conductive screen, and (c) prevents electrical arcing between the electrically conductive screens during the electric glow discharge. In another aspect, the non-conductive granular material comprises marbles, ceramic beads, molecular sieve media, sand, limestone, activated carbon, zeolite, zirconium, alumina, rock salt, nut shell or wood chips. In another aspect, an electrical power supply is electrically connected to the first and second electrical terminals. In another aspect, the electrical power supply operates in a range from 50 to 500 volts DC, or 200 to 400 volts DC. In another aspect, the first electrically conductive screen or the second electrically conductive screen reaches a temperature of at least 500° C., 1000° C., or 2000° C. during the electric glow discharge. In another aspect, once the electric glow discharge is created, the electric glow discharge is maintained without the electrically conductive fluid. In another aspect, the electrically conductive fluid comprises water, produced water, wastewater or tailings pond water. In another aspect, the electrically conductive fluid comprises a fluid containing an electrolyte. In another aspect, the electrolyte comprises baking soda, Nahcolite, lime, sodium chloride, ammonium sulfate, sodium sulfate or carbonic acid. In another aspect, the apparatus is configured for installation within a fluid transfer device comprising a tank, vessel, stripper column, reactor, pipe or conduit. In another aspect, the apparatus further comprises a fluid transfer device having a first flange and a second flange, wherein the fluid transfer device comprising a tank, vessel, stripper column, reactor, pipe or conduit; and the housing is attached between the first flange and the second flange. In another aspect, the apparatus comprises one or more sensors disposed within the housing. In another aspect, the first and second conductive filter screens or the non-conductive granular material are removably disposed within the housing.

### Industrial Use Example

FIG. 10 is a cross-sectional view of a PLASMA ELECTROLYSIS STRIPPER COLUMN™ 1000 in accordance with on embodiment of the present invention. A pair of EGD assemblies 900a and 900b are installed in a vessel 1002 in order to convert it to a stripper and/or separator 1000. Water or fluid 1004 flows into inlet 1006 above the first EGD assembly 900a and flows down over the first EGD assembly 900a in order to strip gases, generate steam, separate fluids (e.g., oil and water), break emulsions, generate bleach, generate sodium chlorate and/or generate hydrogen. The water vapor and stripped gasses 1008 rise and exit through outlet 1010. The second EGD assembly 900b is placed in series with and below the first EGD assembly 900a. The stripped water or fluid 1012 flows out the bottom through outlet 1014. Note that it is not necessary to place the second EGD assembly 900b on the same tank, vessel, stripper column, reactor, pipe or conduit. Moreover, more than two EGD assemblies 900 can be used.

Macondo Deepwater Horizon Oil Spill

On Apr. 20, 2010 the Deepwater Horizon Semi-Submersible Drilling Rig experienced the largest blowout and consequently the largest marine oil spill within the history of the petroleum industry. Turning now to FIGS. 10 and 11 the apparatus 1000 can be installed on the sea floor 1102 as a means for separating oil, gas and water as well as treating the water that may have residual amounts of entrained hydrocarbons. As a result, this embodiment provides a SURFACE AND SUBSEA PLASMA ELECTROLYSIS METHANE HYDRATE BUSTER™ 1000.

The inventor of the present invention has tested various emulsions with an Electric Glow Discharge cell. All emulsions were broken with the EGD Cell. Consequently, one of the methods for treating oil spills is to add a dispersant. However, this creates a problem in that it forms an emulsion. Thus, by locating the present invention on the Sea Floor, a supply vessel, and/or drilling rig, this gives the Oil & Gas Operator an assurance means for being able to treat oil spills.

Accordingly, the system for creating an electric glow discharge comprises: a fluid transfer device having one or more sets of first flanges and second flanges, wherein the fluid transfer device comprising a tank, vessel, stripper column, reactor, pipe or conduit; an electric glow discharge device attached between each set first flanges and second flanges, where each electric glow discharge device comprises: a non-conductive housing having a longitudinal axis, a first opening aligned with the longitudinal axis, and a second opening aligned with the longitudinal axis and opposite the first opening, a first electrically conductive screen disposed proximate to the first opening of the housing and substantially perpendicular to the longitudinal axis, a second electrically conductive screen disposed proximate to the second opening of the housing and substantially perpendicular to the longitudinal axis, wherein the second electrically conductive screen separated from the first electrically conductive screen by a substantially equidistant gap, a non-conductive granular material disposed within the substantially equidistant gap, a first electrical terminal electrically connected to the first electrically conductive screen and disposed on an exterior of the housing, and a second electrical terminal electrically connected to the second electrically conductive screen and disposed on an exterior of the housing; an electrical power source electrically connected to the first and second electrical terminals; and wherein the electric glow discharge is created whenever the first electrical terminal is connected to an electrical power supply such that the first electrically conductive screen has a first polarity, the second electrical terminal is connected to the electrical power supply such that the second electrically conductive screen has a second polarity, and an electrically conductive fluid is introduced into the substantially equidistant gap.

In one aspect, the non-conductive granular material (a) does not pass through either electrically conductive screen, (b) allows the electrically conductive fluid to flow between the first electrically conductive screen and the second electrically conductive screen, and (c) prevents electrical arcing between the electrically conductive screens during the electric glow discharge. In another aspect, the non-conductive granular material comprises marbles, ceramic beads, molecular sieve media, sand, limestone, activated carbon, zeolite, zirconium, alumina, rock salt, nut shell or wood chips. In another aspect, the electrical power supply operates in a range from 50 to 500 volts DC, or 200 to 400 volts DC. In another aspect, the first electrically conductive screen or the second electrically conductive screen reaches a temperature of at least 500° C., 1000° C., or 2000° C. during the electric glow discharge. In another aspect, once the electric glow discharge is created, the electric glow discharge is maintained without the electrically conductive fluid. In another aspect, the electrically conductive fluid comprises water, produced water, wastewater or tailings pond water. In another aspect, the electrically conductive fluid comprises a fluid containing an electrolyte. In another aspect, the electrolyte comprises baking soda, Nahcolite, lime, sodium chloride, ammonium sulfate, sodium sulfate or carbonic acid. In another aspect, the system further comprises one or more sensors disposed within the housing. In another aspect, the first and second conductive filter screens or the non-conductive granular material are removably disposed within the housing.

Moreover, the present invention provides a method for creating an electric glow discharge by providing a glow discharge apparatus comprising: a non-conductive housing having a longitudinal axis, a first opening aligned with the longitudinal axis, and a second opening aligned with the longitudinal axis and opposite the first opening, a first electrically conductive screen disposed proximate to the first opening of the housing and substantially perpendicular to the longitudinal axis, a second electrically conductive screen disposed proximate to the second opening of the housing and substantially perpendicular to the longitudinal axis, wherein the second electrically conductive screen separated from the first electrically conductive screen by a substantially equidistant gap, a non-conductive granular material disposed within the substantially equidistant gap, a first electrical terminal electrically connected to the first electrically conductive screen and disposed on an exterior of the housing, and a second electrical terminal electrically connected to the second electrically conductive screen and disposed on an exterior of the housing; connecting the first and second electrical terminals to an electrical power supply such that the first electrically conductive screen has a first polarity, and the second electrically conductive screen has a second polarity; and creating the electric glow discharge by introducing an electrically conductive fluid into the substantially equidistant gap. The aspects described above with respect to the apparatus and system are also applicable to the method.

Reverse Polarity EGD Screen Assembly

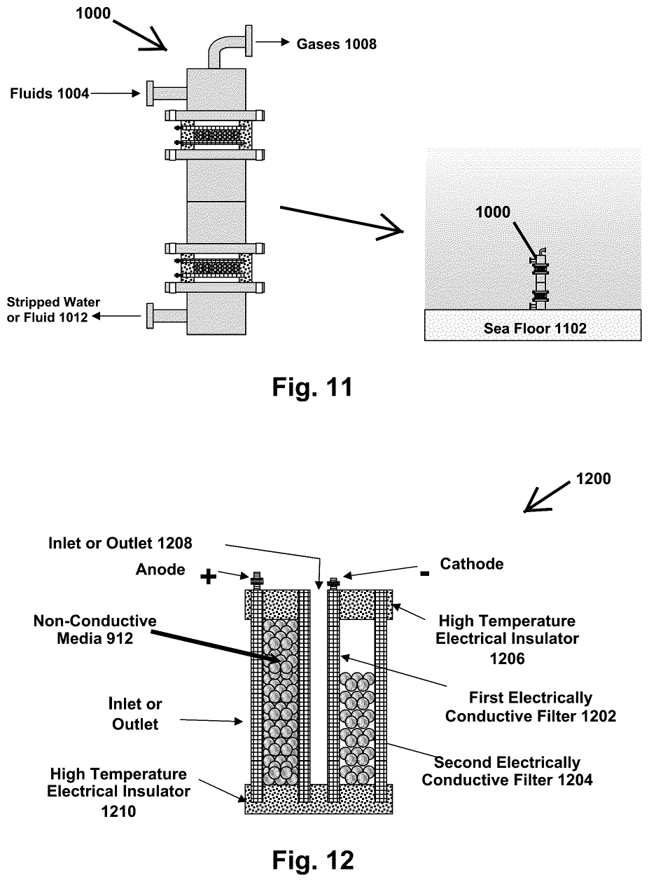

FIG. 12 is a cross-sectional view of a Plasma Electrolysis Well Screen™ or Filter Screen or EGD Tube Assembly 1200 in accordance with on embodiment of the present invention. In this embodiment, the polarity of the screens is reversed when compared and contrasted to the disclosures of FIGS. 3 and 4. In comparison, the assemblies are similar in that a first electrically conductive inner screen 1202 is disposed within a larger second electrically outer screen 1204 and the annulus or gap between the screens is filled with a non-conductive media 912. The inner and outer screens 1202 and 1204 are potted, cast, cemented or affixed to a first non-conductive end 1206 and a second non-conductive end 1206. One end of the non-conductive material 1206 has a hole 1208 within the center for fluid to flow in or out of the inner screen 1202. The other end of the non-conductive material 1210 is closed. In addition, fluid can flow in or out of the EGD Tube Assembly 200 via the outer screen 1204. However, in contrast to FIGS. 3 and 4, the EGD Tube Assembly 1200 uses the first electrically conductive inner screen 1202 as the cathode and the second electrically conductive outer screen 1204 as the anode. An electric glow discharge is formed when power is supplied to the first screen and the second screen, and an electrolyte is flowed into the EGD Tube Assembly 1200 in order to close the electrical circuit. However, it will be understood that once electrically conductive matter, such as salts, are deposited upon the media, the EGD Tube Assembly 200 will still function properly even when a non-conductive fluid is used.

Insertable Plasma Electrolysis Assembly

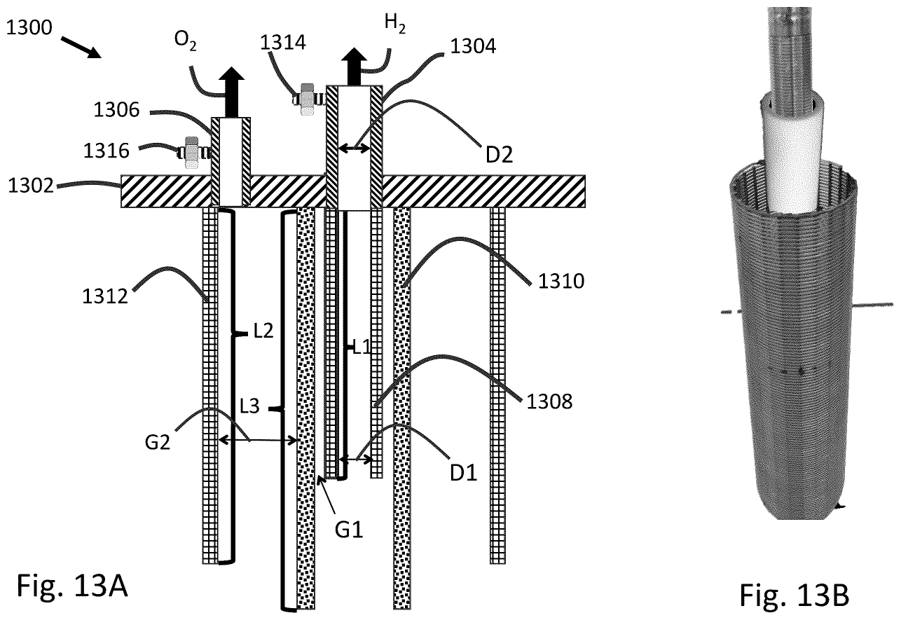

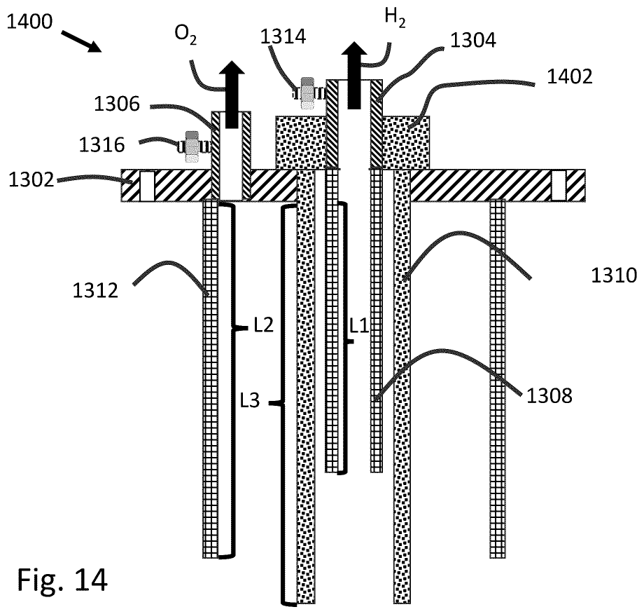

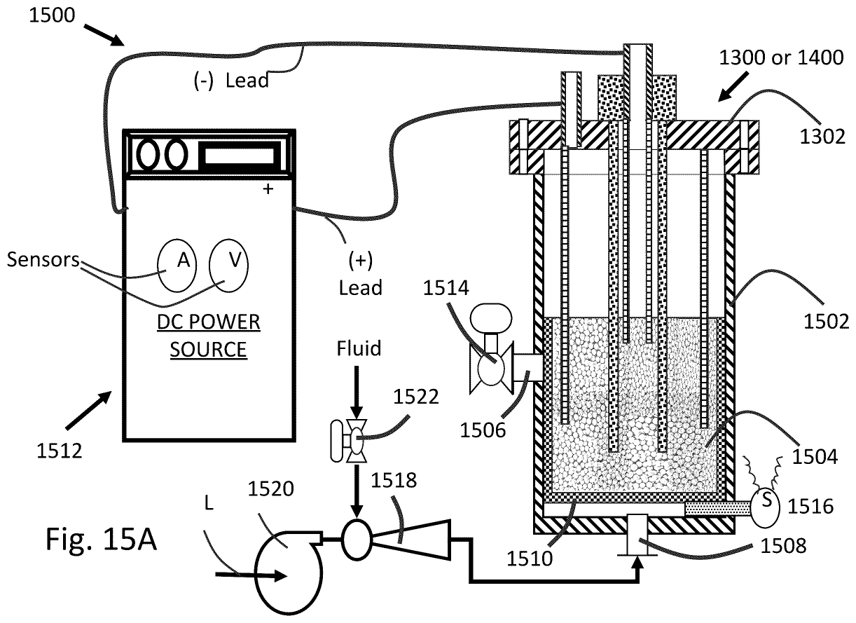

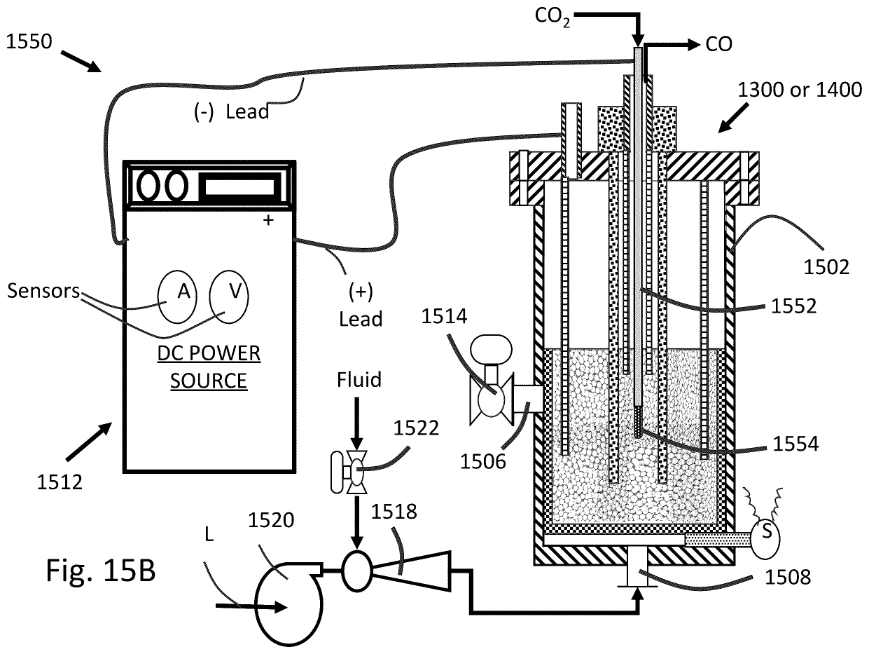

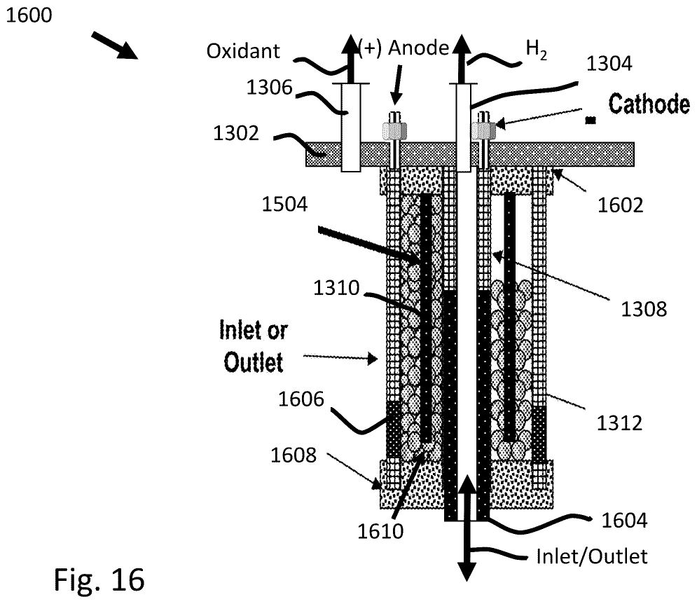

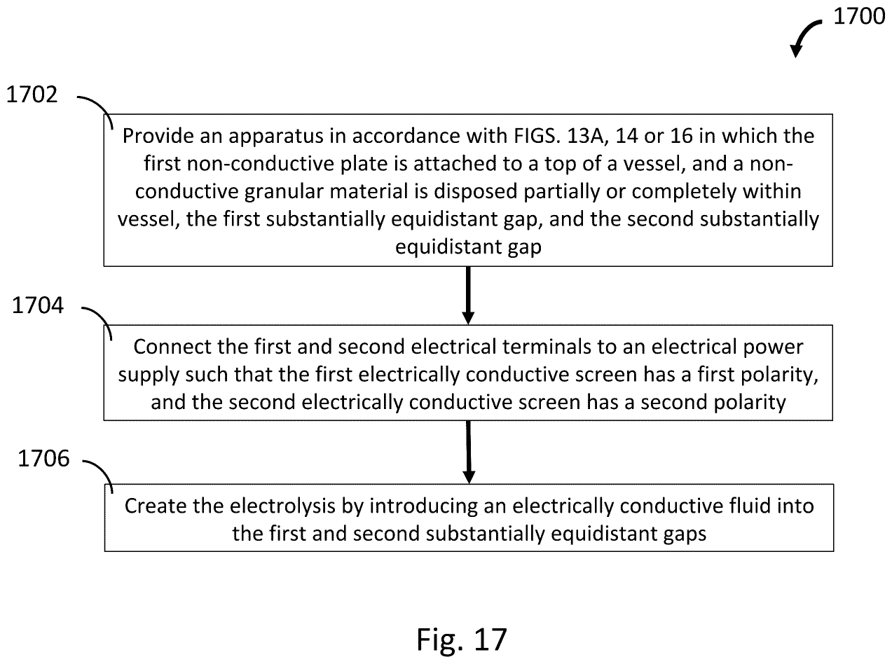

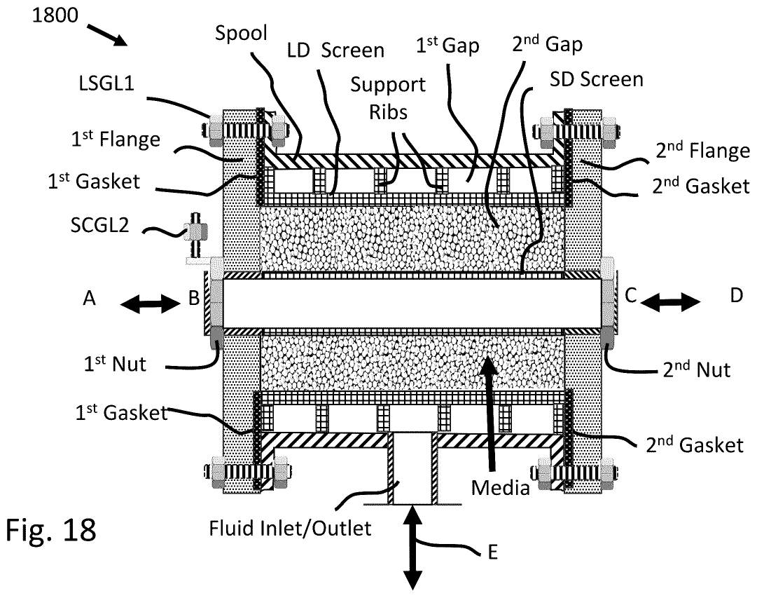

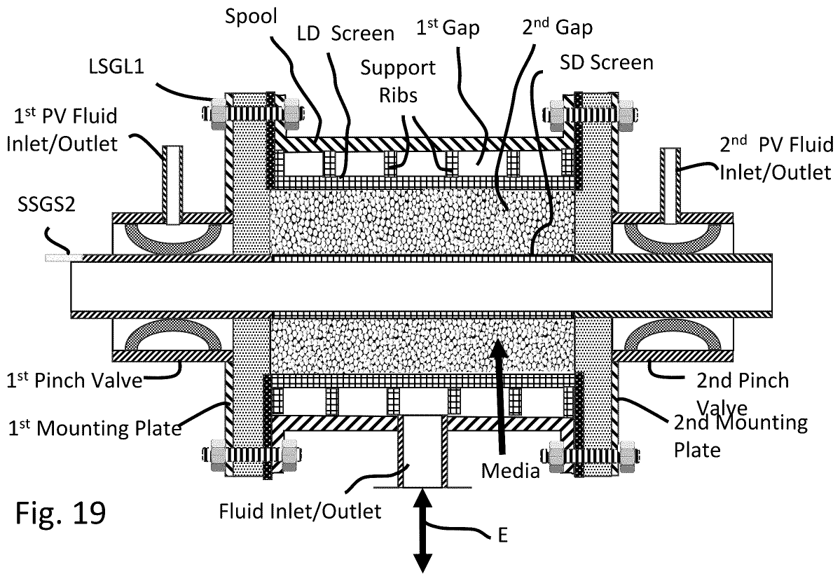

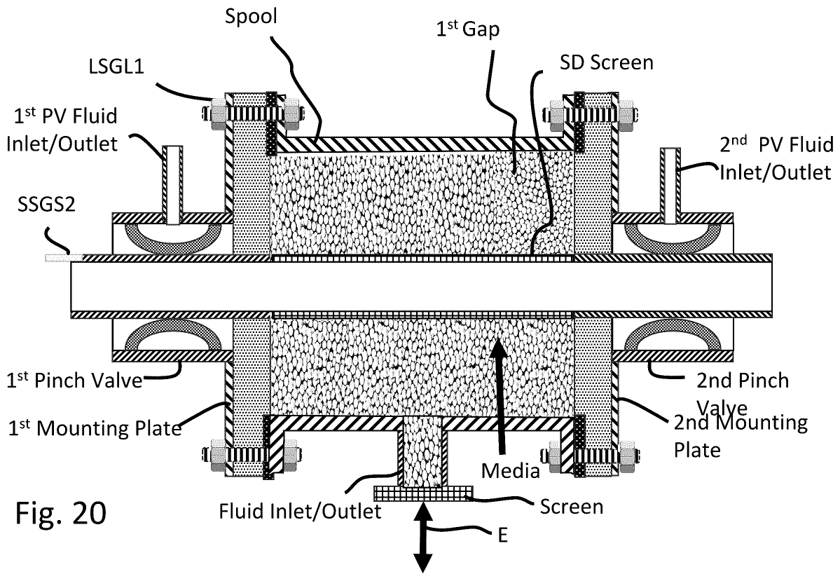

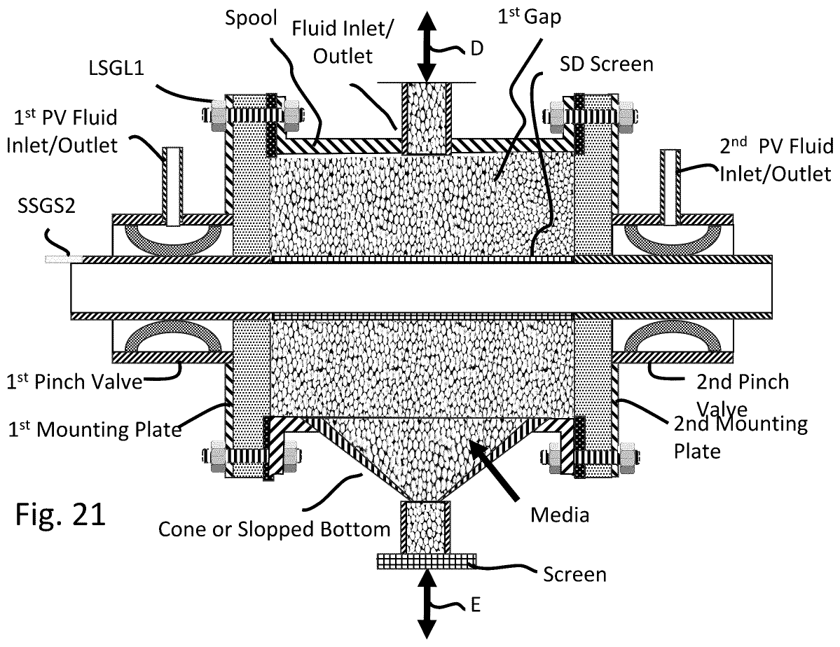

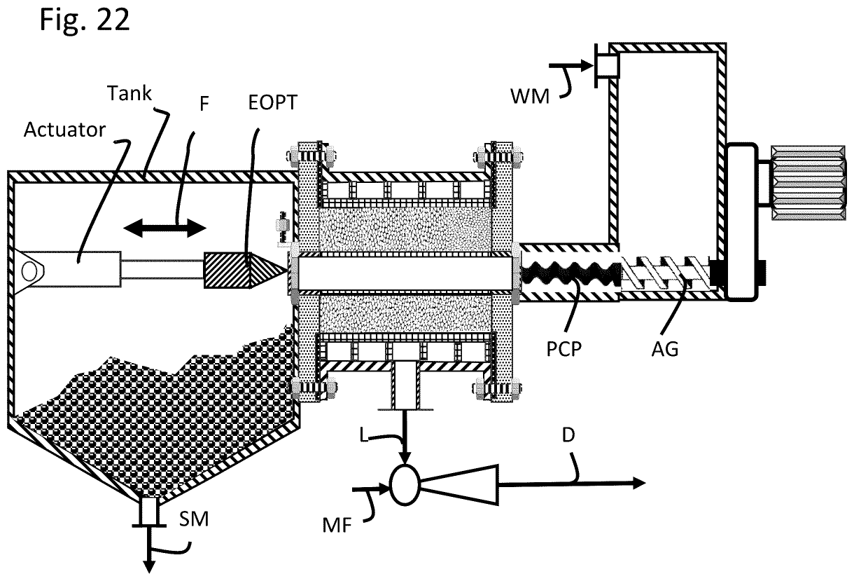

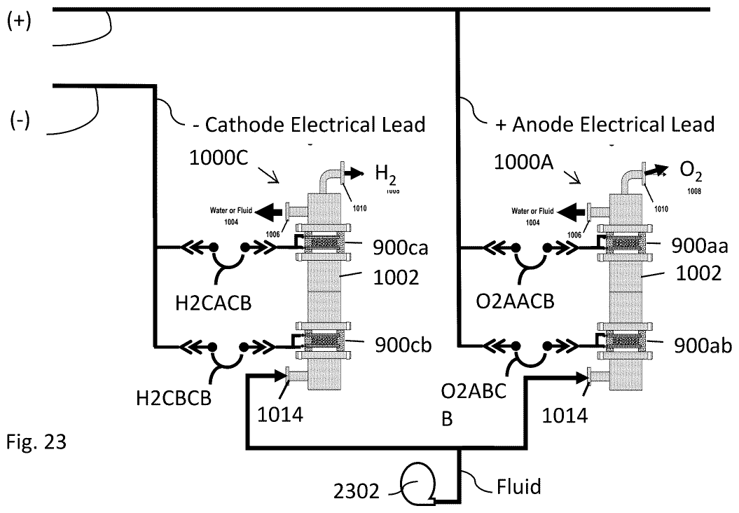

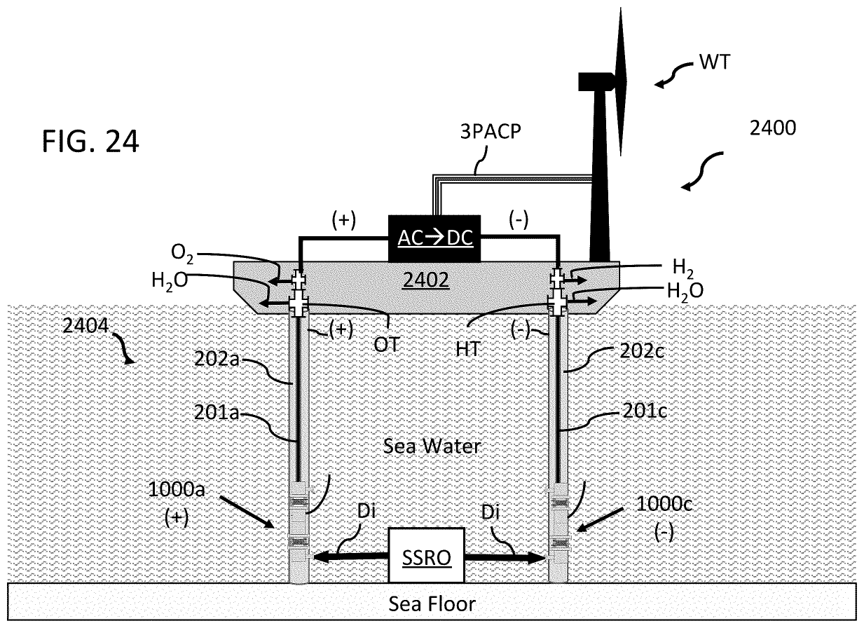

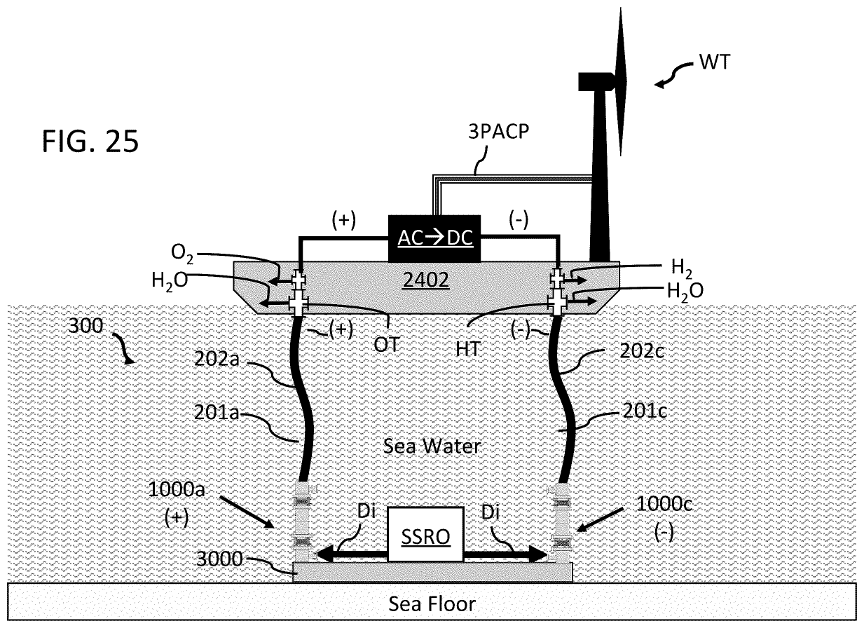

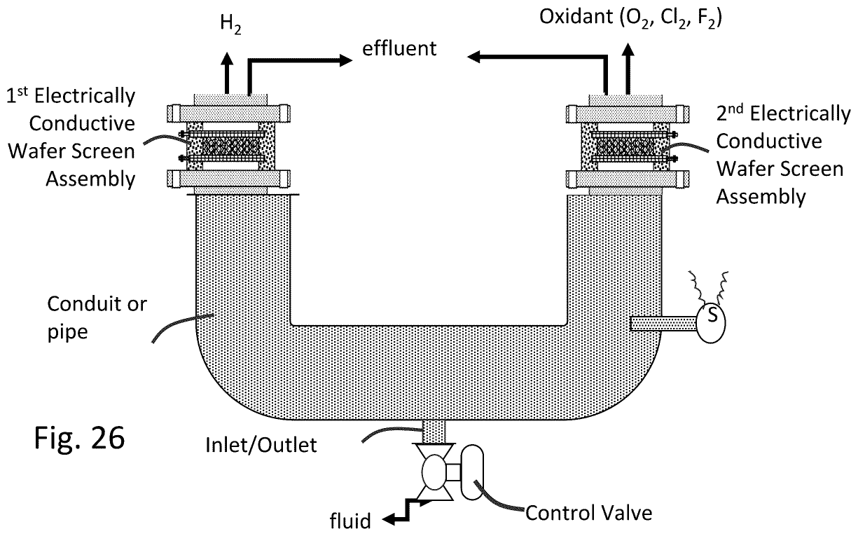

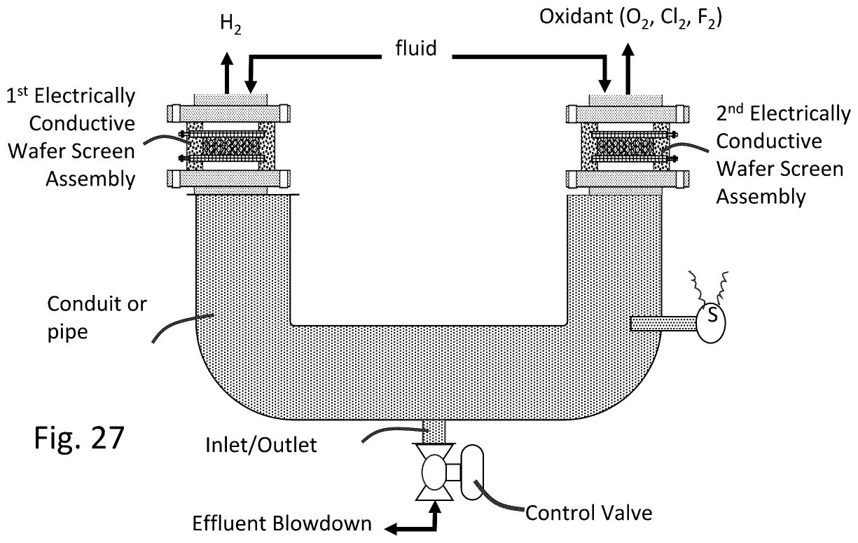

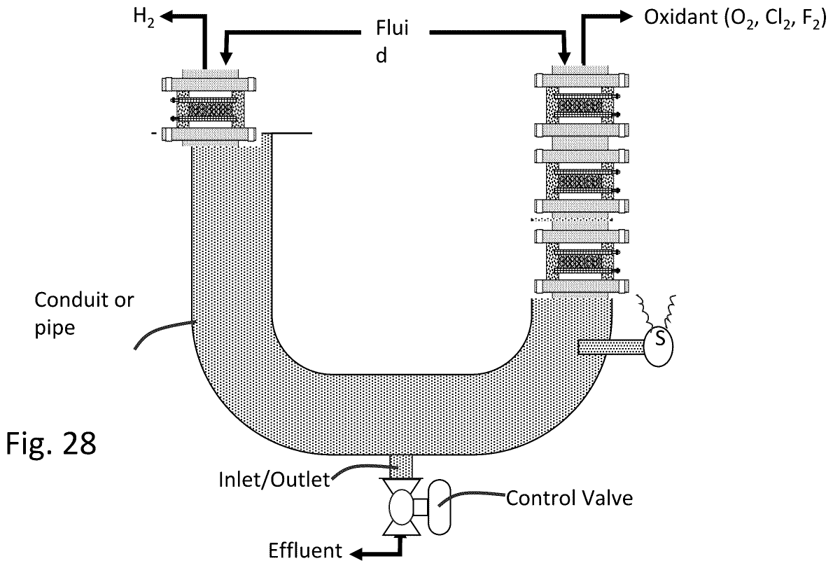

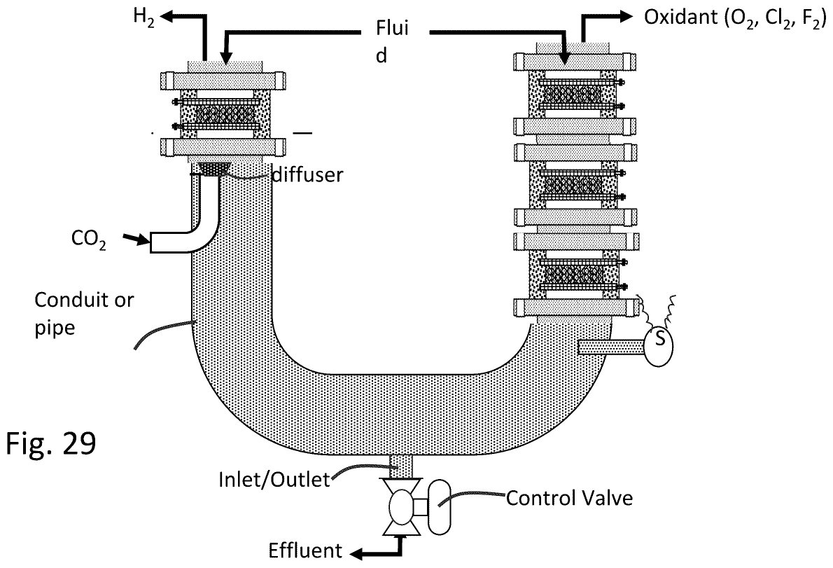

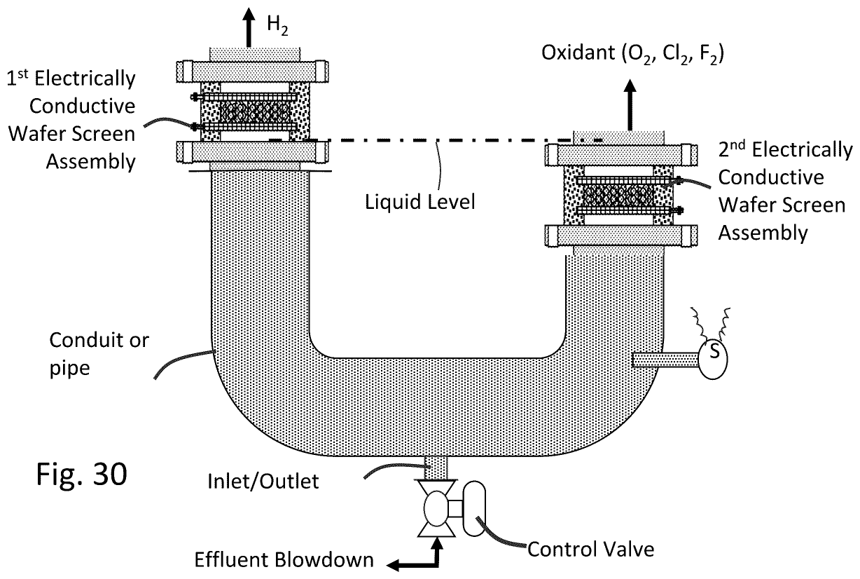

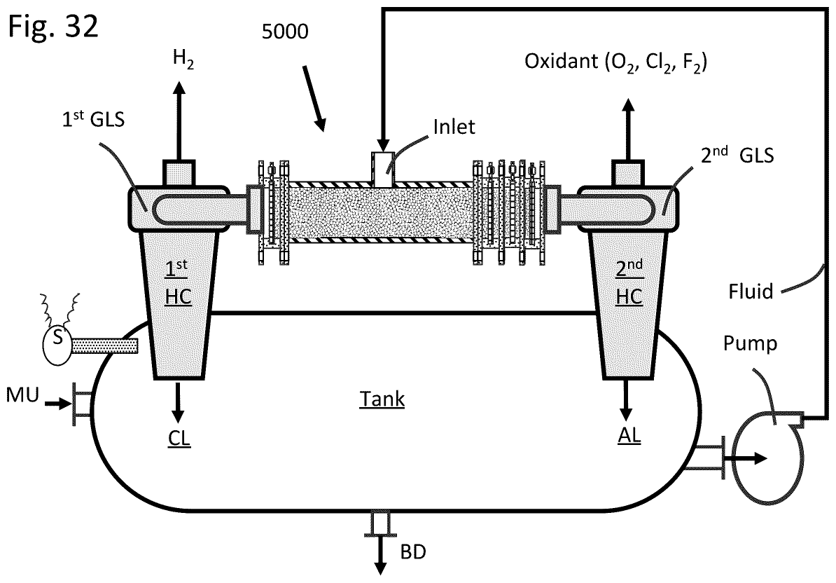

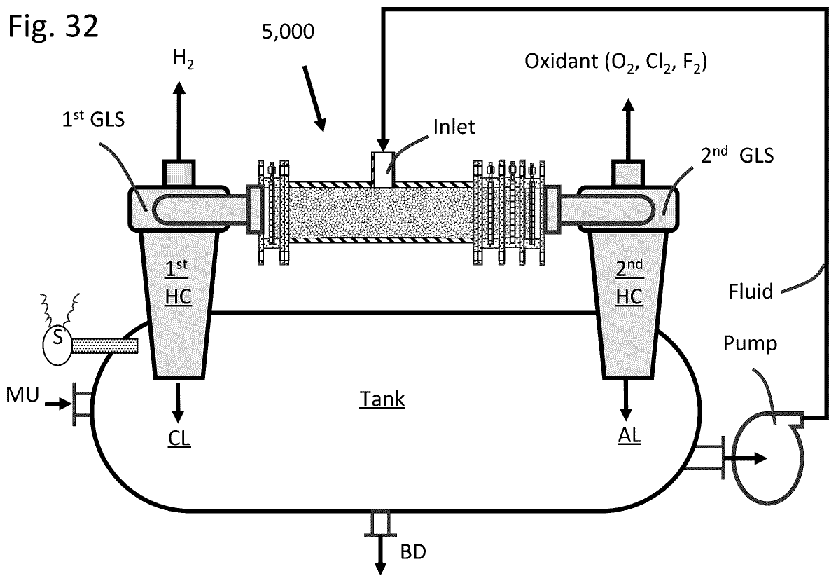

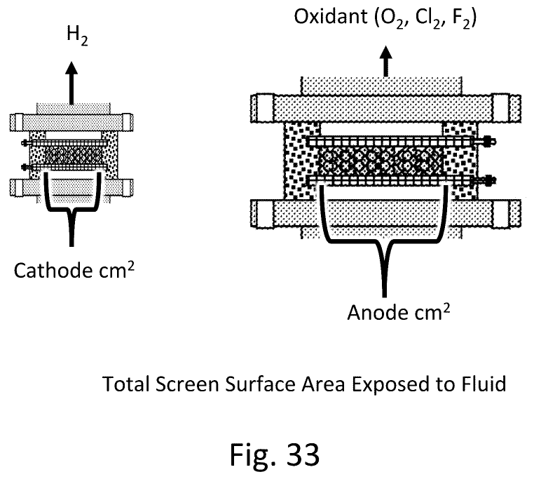

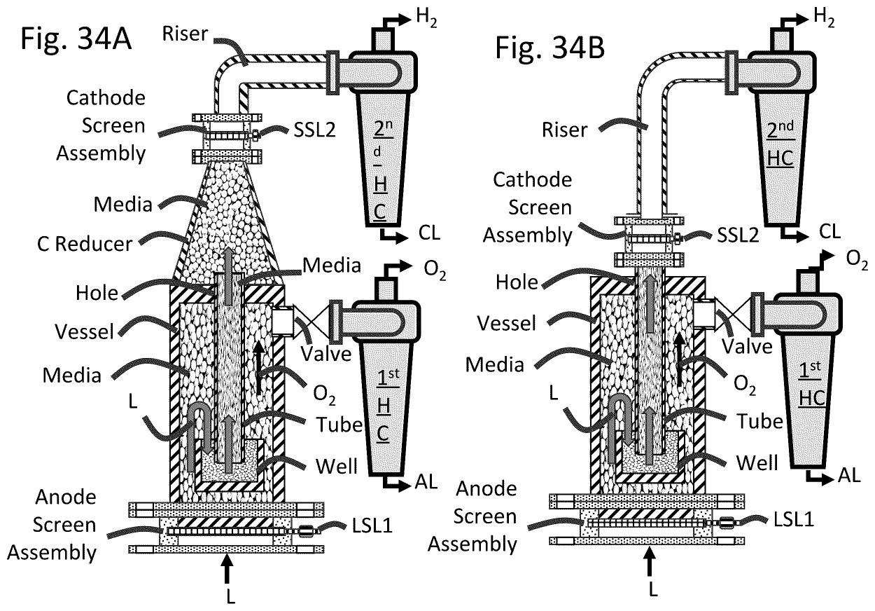

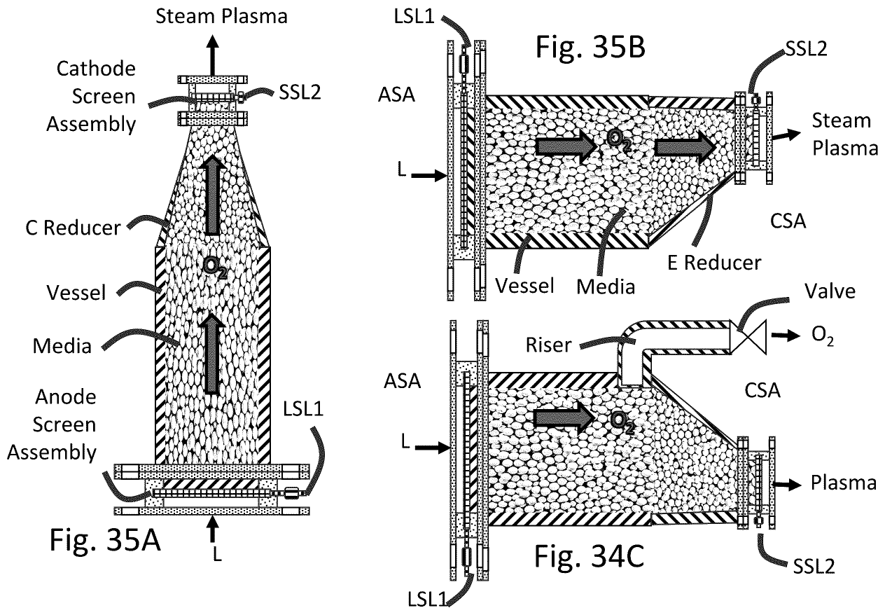

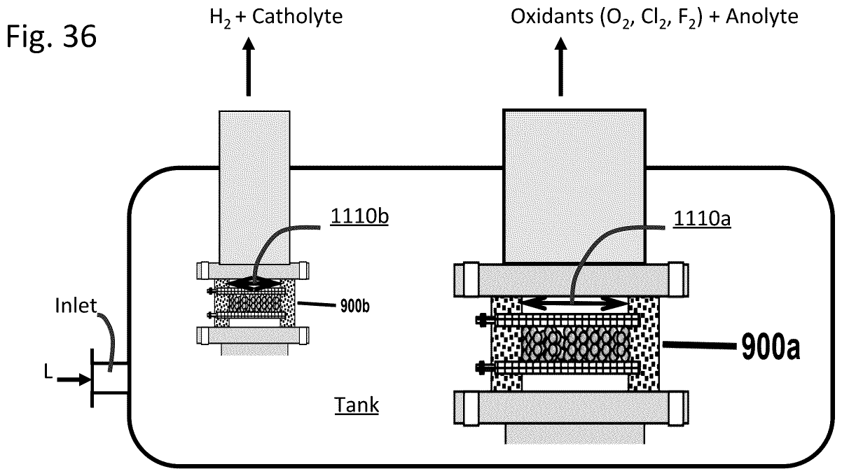

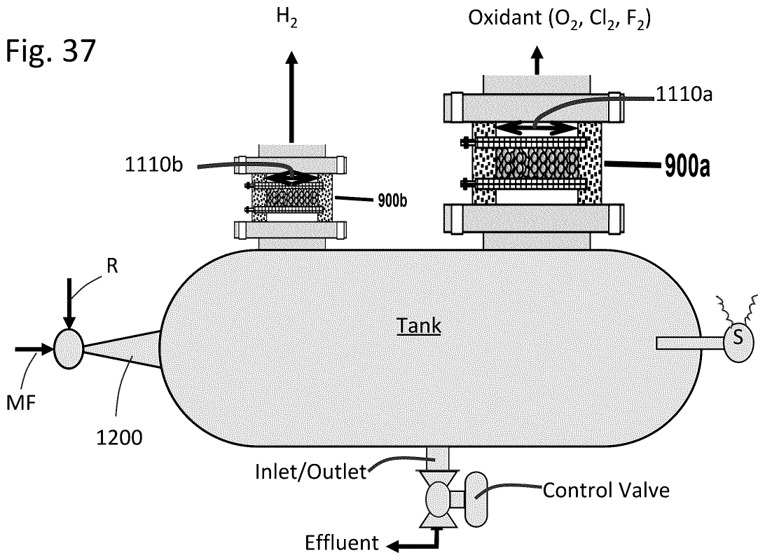

Turning now to FIG. 13A, an insertable plasma electrolysis assembly 1300 is shown in accordance with one embodiment of the present invention. The insertable plasma electrolysis apparatus 1300 includes a first non-conductive plate 1302 having a first outlet 1304 and a second outlet 1306. A first cylindrical conductive screen 1306 extends below the first non-conductive plate 1302 proximate to the first outlet 1304 such that a inner diameter D1 of the first cylindrical conductive screen 1308 is greater than or equal to an inner diameter D2 of the first outlet 1304. A cylindrical non-conductive tube 1310 extends below the first non-conductive plate 1302 such that the cylindrical non-conductive tube 1310 is disposed around the first cylindrical conductive screen 1308 with a first substantially equidistant gap G1 between the first cylindrical conductive screen 1308 and the cylindrical non-conductive tube 1310. A second cylindrical conductive screen 1312 extends below the first non-conductive plate 1302 such that the second cylindrical conductive screen 1312 is disposed around the cylindrical non-conductive tube 1310 with a second substantially equidistant gap G2 between the cylindrical non-conductive tube 1312 and the second cylindrical conductive screen 1310. As used herein, the screens can be any conductive material that prevents the non-conductive granular material from flowing through it, such as mesh, or slits, holes or other openings in a solid material. The second outlet 1306 is either disposed between the cylindrical non-conductive tube 1310 and the second cylindrical conductive screen 1312 as shown in FIG. 13A, or outside of the second cylindrical conductive screen 1312 as shown in FIG. 16. A first electrical terminal 1314 is coupled to the first cylindrical conductive screen 1304, and a second electrical terminal 1316 is coupled to the second cylindrical conductive screen 1312 as shown in FIG. 16. Alternatively, the first electrical terminal 1314 is connected to the first outlet 1304, which is electrically conductive and attached to the first cylindrical conductive screen 1308, and the second electrical terminal 1316 is connected to the second outlet 1306, which is electrically conductive and attached to the second cylindrical conductive screen 1312 as shown in FIG. 13A. A length L1 of the first cylindrical conductive screen 1308 is less that a length L2 of the second cylindrical conductive screen 1312, and a length L3 of the cylindrical non-conductive tube 1310 is greater than the length of the second cylindrical conductive screen 1312. An exploded view of the positional relationship of the first cylindrical conductive screen 1308, the cylindrical non-conductive tube 1310 and the second cylindrical conductive screen 1312 is shown in FIG. 13B. The first cylindrical conductive screen 1308, the cylindrical non-conductive tube 1310 and the second cylindrical conductive screen 1312 can be attached to, formed within, integrated into, or extend through the first non-conductive plate 1302 by any means known in the art (e.g., a high temperature ceramic glue).

In one aspect, the apparatus is configured to be inserted into a vessel, pipe, conduit, column, tank, well or any structure that holds a fluid to form a closed system as illustrated in FIGS. 15 and 16. In another aspect, the first cylindrical conductive screen comprises a cathode and the second cylindrical conductive screen comprises an anode. In another aspect, the first cylindrical conductive screen is substantially aligned with a longitudinal axis of the first outlet. In another aspect, the first outlet and the second outlet extend above a top of the first non-conductive plate. In another aspect, the first electrical terminal is connected to the first outlet, and the first outlet is electrically conductive and attached to the first cylindrical conductive screen, and the second electrical terminal is connected to the second outlet, and the second outlet is electrically conductive and attached to the second cylindrical conductive screen. In another aspect, a second non-conductive plate is attached above (see FIG. 14) or below (see FIG. 16) the first non-conductive plate. In another aspect, the first cylindrical conductive screen is attached to the second non-conductive plate. In another aspect, the cylindrical non-conductive tube is attached to the second non-conductive plate. In another aspect, the second cylindrical conductive screen is attached to the second non-conductive plate. In another aspect, the cylindrical non-conductive tube comprises a third cylindrical non-conductive tube, and further comprising: a first cylindrical non-conductive tube attached to a bottom of the first cylindrical conductive screen or an extension of the first cylindrical conductive screen that is coated with a non-conductive material; a second cylindrical non-conductive tube attached to a bottom of the second cylindrical screen or an extension of the second cylindrical conductive screen that is coated with the non-conductive material; and a third non-conductive plate attached to a bottom of the first cylindrical non-conductive tube or a bottom of the extension of the first cylindrical conductive screen, a bottom of the second cylindrical non-conductive tube or a bottom of the extension of the second cylindrical conductive screen, wherein a third gap is formed between the third non-conductive plate and a bottom of the third cylindrical non-conductive tube (see FIG. 16). In another aspect, an opening is disposed in the third non-conductive plate and connected to the first cylindrical tube. In another aspect, a non-conductive granular material is disposed partially or completely within the first substantially equidistant gap and the second substantially equidistant gap. In another aspect, the non-conductive granular material (a) does not pass through the first cylindrical conductive screen and the second cylindrical conductive screen, (b) allows an electrically conductive fluid to flow between the first cylindrical conductive screen and the second cylindrical conductive screen, and (c) prevents electrical arcing between the first and second cylindrical conductive. In another aspect, the non-conductive granular material comprises marbles, ceramic beads, molecular sieve media, sand, limestone, activated carbon, zeolite, zirconium, alumina, rock salt, nut shell or wood chips.

Now also turning to FIG. 14, an insertable plasma electrolysis assembly 1400 is shown in accordance with another embodiment of the present invention. This embodiment is similar to the embodiment shown in FIG. 13A, except that a second non-conductive plate 1402 is attached above the first non-conductive plate 1302. As shown, the first cylindrical conductive screen 1308 is attached to the second non-conductive plate 1402, and the cylindrical non-conductive tube 1310 is attached to the second non-conductive plate 1402. The first cylindrical conductive screen 1308 and the cylindrical non-conductive tube 1310 can be attached to, formed within, integrated into, or extend through the second non-conductive plate 1402 by any means known in the art (e.g., a high temperature ceramic glue).

Turning now to FIG. 15A, a plasma electrolysis apparatus or system 1500 is shown in accordance with another embodiment of the present invention. The plasma electrolysis apparatus or system 1500 includes a vessel 1502 and the insertable plasma electrolysis assembly 1300 (FIG. 13A) or 1400 (FIG. 14) inserted into the vessel 1502 such that the first non-conductive plate 1302 is attached to a top of the vessel 1502. The vessel 1502 can be a pipe, conduit, column, tank, well or any structure that holds a fluid to form a closed system. A non-conductive granular material 1504 is disposed partially or completely within vessel, the first substantially equidistant gap, and the second substantially equidistant gap. A first vessel inlet or outlet 1506 is disposed in a side of the vessel 1502. A second vessel inlet or outlet 1508 is disposed in a bottom of the vessel 1502 or the side of the vessel 1502 proximate to the bottom of the vessel 1502. One or more screens or filters 1510 are disposed within or proximate to the first vessel inlet or outlet and the second vessel inlet or outlet, wherein the non-conductive granular material 1504 does not pass through the one or more screens or filters 1510.

In addition, a power supply 1512 is electrically coupled to the first cylindrical conductive screen 1308 and the second cylindrical conductive screen 1312. The power supply 1512 includes various sensors, such as current A and voltage V. A tank control valve 1514 is coupled to the first vessel inlet or outlet 1506. One or more sensors 1516 monitor one or more parameters within the vessel 1502, such as total dissolved solids (TDS), pH, total suspended solids (TSS), oxidation reduction potential (ORP), temperature, or other desirable parameters. In some embodiments, an eductor 1518 has an outlet is coupled to the second vessel inlet or outlet 1508. A pump 1520 is coupled to the first inlet of the eductor 1518, and a control valve 1522 is coupled to the second inlet of the eductor 1518. The pump 1520 is preferably controlled with a variable frequency drive. When the eductor 1518 is not used, the pump 1520 is coupled to the second vessel inlet/outlet 1508.

During operation, an electrically conductive fluid is disposed within the vessel. The electrically conductive fluid can be water, produced water, wastewater or tailings pond water. The electrically conductive fluid can also be a fluid containing an electrolyte, such as baking soda, Nahcolite, lime, sodium chloride, ammonium sulfate, sodium sulfate or carbonic acid. The negative (−) lead of the DC power source 1512 is attached to the first cylindrical conductive screen 1308, and the positive (+) lead is attached to the second cylindrical conductive screen 1312. The plasma electrolysis apparatus or system 1500 may be operated in several modes: Plasma Electrolysis, Faraday Electrolysis, Plasma Electrolysis Steam, and Plasma Electrolysis CO₂ Reduction.

Plasma Electrolysis Mode of Operation

Turn ON power supply 1512.

Turn ON P/VFD pump 1520.

Liquid (L) flows into the vessel 1502.

Amp sensor monitors for electrical current flow.

When the liquid reaches the first cylindrical conductive screen, the Volt sensor should show open circuit voltage (OCV=Max Voltage of Power Source) and a plasma will be formed on first cylindrical conductive screen (cathode).

Control valve 1514 is set to maintain OCV via monitoring amps and voltage.

Amps are set to desired limit to increase or decrease gas production in Plasma Electrolysis Mode.

Both the P/VFD pump 1520 and the control valve are automatically controlled with amp and volt sensors to maintain plasma electrolysis on the cathode or first cylindrical conductive screen 1308 while maximizing H₂ production.

Faraday Electrolysis Mode of Operation

Turn ON power supply 1512.

Turn ON P/VFD pump 1520.

Liquid (L) flows into the vessel 1502.

Amp sensor monitors for electrical current flow.

When the liquid reaches the first cylindrical conductive screen, the Volt sensor should show open circuit voltage (OCV=Max Voltage of Power Source).

Tank continues filling with liquid until the voltage drops and the amps rise. This is readily viewable with analog gauges. This is the tell-tale sign that plasma electrolysis apparatus or system 1500 is operating in Faraday Electrolysis Mode and not Plasma Electrolysis Mode. Hence, a viewable sight glass is not necessary thus eliminating a major “glass cracking” problem in cell design.

Control valve is set to maintain maximum amps of power source.

Amps set to desired limit to increase or decrease gas production in Faraday Electrolysis Mode.

Both P/VFD pump 1520 and control valve are automatically controlled via the sensors to maintain Faraday electrolysis mode on the cathode or first cylindrical conductive screen 1308 while maximizing gas production.

Plasma Electrolysis Steam Mode of Operation

Turn ON power supply 1512.

Turn ON P/VFD pump 1520.

Liquid (L) flows into the vessel 1502.

Amp sensor monitors for electrical current flow.

When the liquid reaches the first cylindrical conductive screen, the Volt sensor should show open circuit voltage (OCV=Max Voltage of Power Source) and a plasma will be formed on first cylindrical conductive screen (cathode).

Control valve 1514 is set to maintain OCV via monitoring amps and voltage.

Amps set to desired limit to increase or decrease gas production in Plasma Electrolysis Mode.

Both P/VFD pump 1520 and control valve are automatically controlled with amp and volt sensors to maintain plasma electrolysis on the cathode or first cylindrical conductive screen 1308 while maximizing H₂ production.

Eductor control valve 1522 is throttled to pull a suction on O₂ outlet via the eductor 1518.

The oxygen will flow upwards once it reaches the cell and mix with H₂ to form steam.

Steam and some H₂ will exit the H₂ outlet.

Now turning to FIG. 15B, a plasma electrolysis apparatus or system 1550 is shown in accordance with another embodiment of the present invention. The plasma electrolysis apparatus or system 1550 is similar to the plasma electrolysis apparatus or system 1500 of FIG. 15A, except an electrically conductive tube 1552 with a porous tip 1554 commonly referred to as a carbonator or carbonation stone is disposed within the first outlet 1304 and extending into the vessel 1502 beyond the length L1 of the first cylindrical conductive screen 1308. This modification allows for the reduction of CO₂.

Plasma Electrolysis CO₂ Reduction Mode of Operation

Turn ON power supply

Turn ON P/VFD pump

Liquid (L) flows into the Filter Vessel

Amp sensor monitors for electrical current flow

Upon Liquid reaching 2^{nd} electrically conductive screen Volt sensor should show Open Circuit Voltage (OCV=Max Voltage of Power Source) and a plasma will be formed on 2^{nd} conductive screen (cathode).

Control valve 1514 is set to maintain OCV via monitoring amps and voltage.

Amps set to desired limit to increase or decrease gas production in Plasma Electrolysis Mode.

Both P/VFD pump 1520 and control valve 1514 are automatically controlled with amp and volt sensors to maintain plasma electrolysis on the cathode or the first cylindrical conductive screen while maximizing H₂ production.

Eductor control valve 1522 is throttled to pull a suction on O₂ outlet via eductor 1518.

CO2 is injected into the electrically conductive tube 1552 with a porous tip 1554.

CO is produced.

Turning now to FIG. 16, a plasma electrolysis apparatus 1600 is shown in accordance with another embodiment of the present invention. This embodiment is similar to the embodiment shown in FIG. 13A, except that a second non-conductive plate 1602 is attached below the first non-conductive plate 1302. As shown, the first cylindrical conductive screen 1308, the cylindrical non-conductive tube 1310, and the second cylindrical conductive screen 1312 are attached to the second non-conductive plate 1602. The first cylindrical conductive screen 1308, the cylindrical non-conductive tube 1310, and the second cylindrical conductive screen 1312 can be attached to, formed within, integrated into, or extend through the second non-conductive plate 1602 by any means known in the art (e.g., a high temperature ceramic glue). A first cylindrical non-conductive tube 1604 is attached to a bottom of the first cylindrical conductive screen 1308 or an extension of the first cylindrical conductive screen 1308 is coated with a non-conductive material. A second cylindrical non-conductive tube 1606 is attached to a bottom of the second cylindrical screen 1312 or an extension of the second cylindrical conductive screen 1312 is coated with the non-conductive material, which ensures that any oxidants formed on the anode screen will not backflow into the interior screen tube and mix with hydrogen. A third non-conductive plate 1608 is attached to a bottom of the first cylindrical non-conductive tube 1604 or a bottom of the extension of the first cylindrical conductive screen 1308, a bottom of the second cylindrical non-conductive tube 1606 or a bottom of the extension of the second cylindrical conductive screen 1312. A third gap 1610 is formed between the third non-conductive plate and a bottom of the third cylindrical non-conductive tube. This allows liquid to flow in either direction from the outer anode screen to the interior screen or from the interior screen to the outer screen. However, this configuration prevents gases from flowing from one screen to the other screen. Consequently, this allows for separating hydrogen from oxidants. As previously disclosed a media 1504 is disposed within the interior to prevent arcing between the outer screen and the interior screen. The plasma electrolysis electrode assembly attaches to a non-conductive top that has an oxygen outlet and a hydrogen outlet. The entire plasma electrolysis electrode assembly 1600 can be installed on top of a tank, inserted into a vessel, filter pod, spool piece or pipe to ensure it is an enclosed device.

Now referring to FIG. 17, a method 1700 for creating electrolysis in accordance with another embodiment of the present invention is shown. An apparatus in accordance with FIG. 13A, 14 or 16 is provided in block 1702 in which the first non-conductive plate is attached to a top of a vessel, and a non-conductive granular material is disposed partially or completely within vessel, the first substantially equidistant gap, and the second substantially equidistant gap. Connect the first and second electrical terminals to an electrical power supply such that the first electrically conductive screen has a first polarity, and the second electrically conductive screen has a second polarity in block 1704. Create the electrolysis by introducing an electrically conductive fluid into the first and second substantially equidistant gaps in block 1706.

In one aspect, the electrically conductive fluid comprises water, produced water, wastewater or tailings pond water. In another aspect, the electrically conductive fluid comprises a fluid containing an electrolyte. In another aspect, the electrolyte comprises baking soda, Nahcolite, lime, sodium chloride, ammonium sulfate, sodium sulfate or carbonic acid. In another aspect, hydrogen exits the first outlet and an oxidant outlet exits the second outlet. In another aspect, the first electrically conductive screen or the second electrically conductive screen reaches a temperature of at least 500° C., 1000° C., or 2000° C. during the electrolysis. In another aspect, once the electrolysis is created, the electrolysis is maintained without the electrically conductive fluid. In another aspect, the vessel comprises a pipe, conduit, column, tank, well or any structure that holds a fluid to form a closed system. In another aspect, the electrical power supply operates in a range from 50 to 500 volts DC, or 200 to 400 volts DC. In another aspect, the first cylindrical conductive screen comprises a cathode and the second cylindrical conductive screen comprises and anode. In another aspect, one or more sensors monitor one or more parameters within the vessel. In another aspect, the apparatus includes an eductor having a first inlet, a second inlet and an outlet, wherein the outlet is coupled to the second vessel inlet or outlet; a pump coupled to the first inlet of the eductor; and a control valve coupled to the second inlet of the eductor. In another aspect, an electrically conductive tube having a porous tip is disposed within the first outlet and extends into the vessel beyond the length of the first cylindrical conductive screen. In another aspect, the method includes producing carbon monoxide from the first output by introducing carbon dioxide into the electrically conductive tube.

Transmitted Power Density (“TPD”)

The TPD of direct resistance heating processes typically range from 10 to 10,000 W/cm². In contrast the TPD of plasma heating processes typically range from 100 to 100,000 W/cm², which is on the order of ten times greater than that of direct resistance heating. As used herein, Faraday Electrolysis or direct resistance heating is referred to as High Dense Transmitted (“HDT”) Power (“HTP”) and plasma heating as Ultra Dense Transmitted (“UDT”) Power. Any UDT Power™ system, method or apparatus compared to a HDT Power system, method or apparatus would be considered a process intensification system, since it can be made smaller for a given transmitted power density. However, what is unobvious, novel and unique is constructing and operating an electrolytic cell in either Faraday Electrolysis or Plasma Electrolysis for making hydrogen and oxidants. Likewise, the system, method and apparatus is preferably controlled using sensors to transition from Faraday Electrolysis to Plasma Electrolysis reliably and without operator input.

Tests demonstrate that the TPD of a plasma system in accordance with various embodiments of the present invention (e.g., HiTemper™ or VIPER™) is at least 34 times better than the TPD of a Faraday Electrolysis system as illustrated in the table below.

| Plasma Electrolysis (PE) | Parameter | Faraday Electrolysis (FE) |
|---|---|---|
| 350 volts | Voltage | 200 volts |
| 50 amps | Current | 125 amps |
| 17,500 watts | Power | 25,000 watts |
| ¼″ (0.635 cm) | Electrode Depth into Electrolyte | 12″ (30.48 cm) |
| 3″ (5 cm) | Electrode Diameter tube | 2″ (5 cm) |
| | (interior + exterior) | |
| 1 in² (6.45 cm²) | Electrode surface area in electrolyte | 48 in² (310 cm²) |
| 2,713 w/cm² | Transmitted Power Density | 81 w/cm² |

High Pressure Cleanable PE Filter

High pressure cleanable filters are available but are not commonly used within filter presses. Likewise, the world is in dire need for a system, method and apparatus that can convert many different types of liquids to hydrogen. Typically this is referred to as water splitting. The major problem with commonly available Faraday Electrolyzers is using pure water. However, the inventor of the present invention has processed manure, biosolids, tailings pond water, produced water, river water, wastewater effluent and many other types of liquid streams thru the Virtual Inertia Plasma ElectrolyzeR™ (VIPER™) aka HiTemper™ shown in U.S. Pat. Nos. 10,117,318 and 10,395,892, which are hereby incorporated by reference in their entirety.

Turning now to FIG. 18, a high temperature and high-pressure Plasma Electrolyzer 1800 is shown in accordance with another embodiment of the present invention. The high temperature and high-pressure Plasma Electrolyzer 1800 includes a spool with a large diameter screen supported with ribs. The ribs may be circumferential, longitudinal or spiral or any combination thereof. The ribs provide extra hoop strength to the screen. Although the ribs are shown it will be understood that in many applications the screen alone may suffice for hoop strength. The spool is sandwiched between a 1^{st} flange and a 2^{nd} flange and includes a 1^{st} gasket and a 2^{nd} gasket. A 1^{st} gap is formed between the spool and the large diameter screen. An outlet is attached to the spool. A small diameter screen is installed within the center of the spool and large diameter screen and along the longitudinal axis between the 1^{st} and 2^{nd} flanges. A 2^{nd} gap is formed between the large diameter screen and the small diameter screen. The 2^{nd} gap is filled with media. The ideal media is ceramic proppant or frac sand used to fracture oil and gas wells. Since ceramic proppant can withstand extremely high pressures. When the large screen's grounding lug 1 and the small screen's grounding lug 2 are connected to opposite polarities on a DC source an unique, novel and unobvious configuration emerges for using the Plasma Electrolyzer 2000 as a filter press screen.

The small diameter screen is held in place with means known in the art such as a 1^{st} nut and 2^{nd} nut with acme threads, compression fittings or air operated pinch valves as shown in FIG. 19. This allows for removal of the small diameter screen and filling the 2^{nd} gap with media. For filtration purposes fluid is flowed into the small diameter screen as shown by arrows AB or CD. Likewise, fluid can flow through the spool inlet/outlet as shown by arrow E.

However, for ideal flow-thru filtration for material such as cattle manure the Plasma Electrolyzer 1800 would be installed with an auger attached to a high-pressure progressive cavity-pump or simply a screw press. Turning now to FIG. 20, the Plasma Electrolyzer is sandwiched between a progressive cavity-pump with an auger and a tank containing an Electrode Or Plasma Torch EOPT. The EOPT is attached to an actuator to push or retract the EOPT towards or away from the Plasma Electrolyzer as shown by arrow F. The tank has a bottom solid material SM exit.

An eductor is attached to the bottom outlet of the Plasma Electrolyzer filter screen. It is used to ensure all fluids (liquids and gases) are pulled through the filter screens. There are numerous modes of operation for the Plasma Electrolyzer Filter Screen.

Plasma Electrolysis Mode of Operation

Large Screen Lug 1 hooked up to positive side of DC Power source.

Small Screen Lug 2 hooked up to negative side of DC Power source.

Turn ON Power Supply.

Flow Wet Material into inlet of Auger PGP.

Liquids begin to go thru small screen and upon contact with large screen a glow discharge is formed on small screen.

All liquids going through the screen are treated.

EOPT is not energized.

EOPT is used only to create a plug near the end of the small screen to ensure wet material is squeezed under hydraulic pressure.

Steam Plasma Torch Syngas Mode of Operation

Plasma Torch is attached to actuator.

Large Screen Lug 1 and Small Screen Lug 2 are hooked up to positive side of DC Power source.

Plasma Torch Electrode hooked up to negative side of DC Power source.

Turn ON Power Supply and energize plasma torch using Steam as gas for Torch.

Flow Wet Material into inlet of Auger PGP.

Liquids begin to go thru small screen and large screen.

All carbonaceous solids are converted into Syngas.

Eductor pulls a vacuum on Plasma Electrolyzer Filter screen to ensure gases and liquids are pulled into the motive fluid stream.

Electrode Negative Graphite Production Mode of Operation

An electrode is attached to the actuator.

Large Screen Lug 1 and Small Screen Lug 2 are hooked up to positive side of DC Power source.

Electrode is hooked up to negative side of DC Power source.

Turn ON Power Supply and energize electrode and push electrode to touch screen or nozzle (not shown) attached to the small screen.

Flow Wet Material into inlet of Auger PGP.

Liquids begin to go thru small screen and large screen.

All carbonaceous solids are converted into Graphite.

Eductor pulls a vacuum on Plasma Electrolyzer Filter screen to ensure gases and liquids are pulled into the motive fluid stream.

Electrode Positive Graphite Production Mode of Operation

An electrode is attached to the actuator.

Large Screen Lug 1 is hooked up to positive side of DC Power source.

Small Screen Lug 2 is hooked up to negative side of DC Power source.

Electrode is hooked up to positive side of DC Power source.

Turn ON Power Supply and energize electrode and push electrode to touch screen or nozzle (not shown) attached to the small screen.

Flow Wet Material into inlet of Auger PGP.

Liquids begin to go thru small screen and large screen.

All carbonaceous solids are converted into Graphite.

Eductor pulls a vacuum on Plasma Electrolyzer Filter screen to ensure gases and liquids are pulled into the motive fluid stream.

As a result, FIG. 18 provides a method for treating fluent matter with a multiple mode electrolysis filter comprising: a 1^{st} non-conductive flange with a 1^{st} hole, a 1^{st} gasket, a 2^{nd} non-conductive flange with a 2^{nd} hole, a 2^{nd} gasket, a spool piece with a fluid inlet/outlet housing an insertable large diameter electrode filter screen with support ribs which forms a 1^{st} annulus between the spool piece and the insertable large diameter electrode filter screen and a small diameter electrode filter screen with both ends consisting of solid wall tubing in which the small diameter electrode filter screen is inserted into the 1^{st} hole and 2^{nd} hole and affixed to the 1^{st} flange and 2^{nd} flange with compression couplings, which then forms a 2^{nd} annulus between the larger diameter electrode filter screen and small diameter electrode filter screen which the annulus is filled with media to prevent arcing when the screens are attached to opposite polarities of a DC Power Source and a fluid from the fluent matter is flowed into the small electrode screen, thru the media and thru the large filter screen and out the spool piece inlet/outlet or the fluid flow is reversed and flowed into the spool piece via the inlet/outlet, thru the media and thru the small electrode screen and out via either end of the small diameter electrode screen.

As a result, FIG. 19 provides a multiple mode electrolysis filter apparatus for treating fluent matter comprising: a 1^{st} non-conductive flange with a 1^{st} hole, a 1^{st} gasket, a 2^{nd} non-conductive flange with a 2^{nd} hole, a 2^{nd} gasket, a spool piece with a fluid inlet/outlet housing an insertable large diameter electrode filter screen with support ribs which forms a 1^{st} annulus between the spool piece and the insertable large diameter electrode filter screen and a small diameter electrode filter screen with both ends consisting of solid wall tubing in which the small diameter electrode filter screen is inserted into the 1^{st} hole and 2^{nd} hole and affixed to the 1^{st} flange and 2^{nd} flange with pinch valves, which then forms a 2^{nd} annulus between the larger diameter electrode filter screen and small diameter electrode filter screen which the annulus is filled with media to prevent arcing when the screens are attached to opposite polarities of a DC Power Source and a fluid from the fluent matter is flowed into the small electrode screen, thru the media and thru the large filter screen and out the spool piece inlet/outlet or the fluid flow is reversed and flowed into the spool piece via the inlet/outlet, thru the media and thru the small electrode screen and out via either end of the small diameter electrode screen.

FIG. 19 also provides a method for treating fluent matter with a multiple mode electrolysis filter comprising: a 1^{st} non-conductive flange with a 1^{st} hole, a 1^{st} gasket, a 2^{nd} non-conductive flange with a 2^{nd} hole, a 2^{nd} gasket, a spool piece with a fluid inlet/outlet housing an insertable large diameter electrode filter screen with support ribs which forms a 1^{st} annulus between the spool piece and the insertable large diameter electrode filter screen and a small diameter electrode filter screen with both ends consisting of solid wall tubing in which the small diameter electrode filter screen is inserted into the 1^{st} hole and 2^{nd} hole and affixed to the 1^{st} flange and 2^{nd} flange with pinch valves, which then forms a 2^{nd} annulus between the larger diameter electrode filter screen and small diameter electrode filter screen which the annulus is filled with media to prevent arcing when the screens are attached to opposite polarities of a DC Power Source and a fluid from the fluent matter is flowed into the small electrode screen, thru the media and thru the large filter screen and out the spool piece inlet/outlet or the fluid flow is reversed and flowed into the spool piece via the inlet/outlet, thru the media and thru the small electrode screen and out via either end of the small diameter electrode screen.

FIG. 20 provides a multiple mode electrolysis filter apparatus for treating fluent matter comprising: a 1^{st} non-conductive flange with a 1^{st} hole, a 1^{st} gasket, a 2^{nd} non-conductive flange with a 2^{nd} hole, a 2^{nd} gasket, a spool piece which includes and inlet/outlet covered with a screen, a center electrode filter screen with both ends consisting of solid wall tubing inserted into the 1^{st} hole and 2^{nd} hole and affixed to the 1^{st} flange and 2^{nd} flange with pinch valves, the annulus formed between the spool piece and center electrode filter screen is filled with media to prevent arcing when the spool piece and center electrode screen are attached to opposite polarities of a DC Power Source and a fluid from the fluent matter is flowed into the small electrode screen, thru the media and out the spool piece inlet/outlet or the fluid flow is reversed and flowed into the spool piece via the inlet/outlet, thru the media and thru the center electrode screen and out via either end of the small diameter electrode screen.

FIG. 20 also provides a method for treating fluent matter with a multiple mode electrolysis filter comprising: a 1^{st} non-conductive flange with a 1^{st} hole, a 1^{st} gasket, a 2^{nd} non-conductive flange with a 2^{nd} hole, a 2^{nd} gasket, a spool piece which includes and inlet/outlet covered with a screen, a center electrode filter screen with both ends consisting of solid wall tubing inserted into the 1^{st} hole and 2^{nd} hole and affixed to the 1^{st} flange and 2^{nd} flange with pinch valves, the annulus formed between the spool piece and center electrode filter screen is filled with media to prevent arcing when the spool piece and center electrode screen are attached to opposite polarities of a DC Power Source and a fluid from the fluent matter is flowed into the small electrode screen, thru the media and out the spool piece inlet/outlet or the fluid flow is reversed and flowed into the spool piece via the inlet/outlet, thru the media and thru the center electrode screen and out via either end of the small diameter electrode screen.

Turning now to FIG. 21, the plasma electrolysis filter screen of FIGS. 19 and 20 is modified by adding a top fluid/inlet outlet as shown by arrow E and a cone or sloped bottom. The large diameter screen is omitted in this configuration. This configuration allows for flow thru or replenishing the media on an as needed basis even while operating in plasma electrolysis or Faraday electrolysis modes. Although a screen is shown holding back the media, it will be understood that the screen could be a perforated gate valve or a marine type strainer valve allowing for fluid flow but not allowing the media to flow out.

As a result, FIG. 21 provides a multiple mode electrolysis filter apparatus for treating fluent matter comprising: a 1^{st} non-conductive flange with a 1^{st} hole, a 1^{st} gasket, a 2^{nd} non-conductive flange with a 2^{nd} hole, a 2^{nd} gasket, a spool piece which includes a cone or sloped bottom inlet/outlet covered with a screen, a center electrode filter screen with both ends consisting of solid wall tubing inserted into the 1^{st} hole and 2^{nd} hole and affixed to the 1^{st} flange and 2^{nd} flange with pinch valves, the annulus formed between the spool piece and center electrode filter screen is filled with media to prevent arcing when the spool piece and center electrode screen are attached to opposite polarities of a DC Power Source and a fluid from the fluent matter is flowed into the small electrode screen, thru the media and out the spool piece inlet/outlet or the fluid flow is reversed and flowed into the spool piece via the inlet/outlet, thru the media and thru the center electrode screen and out via either end of the small diameter electrode screen.

FIG. 21 also provides a method for treating fluent matter with a multiple mode electrolysis filter comprising: a 1^{st} non-conductive flange with a 1^{st} hole, a 1^{st} gasket, a 2^{nd} non-conductive flange with a 2^{nd} hole, a 2^{nd} gasket, a spool piece which includes a cone or sloped bottom inlet/outlet covered with a screen, a center electrode filter screen with both ends consisting of solid wall tubing inserted into the 1^{st} hole and 2^{nd} hole and affixed to the 1^{st} flange and 2^{nd} flange with pinch valves, the annulus formed between the spool piece and center electrode filter screen is filled with media to prevent arcing when the spool piece and center electrode screen are attached to opposite polarities of a DC Power Source and a fluid from the fluent matter is flowed into the small electrode screen, thru the media and out the spool piece inlet/outlet or the fluid flow is reversed and flowed into the spool piece via the inlet/outlet, thru the media and thru the center electrode screen and out via either end of the small diameter electrode screen.

Virtual Inertia Plasma ElectrolyzeR™ (VIPER™)

Turning now to FIG. 22 while referring back to FIG. 10, two plasma electrolysis wafer style screen columns or reactors would be used to produce hydrogen. This combination allows for a Virtual Inertia Plasma ElectrolyzeR™ herein VIPER™ for grid control. One column would be operated as a cathode and the other as an anode. This configuration can be used for grid control, especially on a DC microgrid. Simply, a pump would be used for flowing fluid into the columns. This effectively electrically connects the wafers within the reactor columns and energizes the cathode and anode wafers. Fluid height or liquid level within the columns dictates whether it is operated in Plasma Electrolysis or Faraday Electrolysis Modes via the following operating steps:

DC Grid Control Plasma Electrolysis Mode for Maximizing H₂ Production

The Cathode Column electrical CIRCUIT BREAKERS are aligned as follows:
H2CACB—CLOSED.
H2CBCB—OPEN.

The Anode Column electrical CIRCUIT BREAKERS are aligned as follows:
O2AACB—CLOSED.
O2ABCB—CLOSED.

PUMP 2302 is turned on and a fluid flows into both columns.

Volts and Amps are monitored and when voltage rises to Open Circuit Voltage (OCV) of the power source and amps drop the system is operating in Glow Discharge aka Plasma Electrolysis Mode to maximize H₂ production.

PUMP 2302 is either turned off or controlled with a Variable Frequency Drive thus maintaining fluid flow into the Columns to ensure it is operated in Plasma Electrolysis Mode.

DC Grid Control Faraday Electrolysis Mode for Maximizing Current Draw

The Cathode Column electrical CIRCUIT BREAKERS are aligned as follows:
H2CACB—CLOSED.
H2CBCB—CLOSED.

The Anode Column electrical CIRCUIT BREAKERS are aligned as follows:
O2AACB—CLOSED.
O2ABCB—CLOSED.

PUMP 2302 is turned on and a fluid flows into both columns.

Volts and Amps are monitored and when voltage rises to Open Circuit Voltage (OCV) of the power source and amps drop the system is operating in Glow Discharge aka Plasma Electrolysis Mode to maximize H₂ production, however PUMP 2302 continues operating until volts drop dramatically and AMPS increase and the system is operating in Faraday Electrolysis Mode.

The system is controlled with a variable frequency drive thus maintaining fluid flow into the columns to ensure it is operated in Faraday Electrolysis Mode.

Although the system of FIG. 22 is shown connected to a DC grid, it will be understood that the DC grid or VIPER™ is connected to a silicon controlled rectifier (SCR). This allows for providing virtual inertia to the grid immediately. This mode is easily controlled with a switch for energizing the SCR. Simply, put VIPER™ would be in standby mode and when virtual inertia is needed on a grid the SCR switch is turned ON or CLOSED. VIPER™ immediately draws power from the grid.

As a result, FIG. 22 provides a multiple mode electrolysis filter press apparatus for treating fluent matter comprising: a material feeder having an input and an output, a multiple mode electrolysis filter screen comprising: a 1^{st} non-conductive flange with a 1^{st} hole, a 1^{st} gasket, a 2^{nd} non-conductive flange with a 2^{nd} hole, a 2^{nd} gasket, a spool piece with a fluid inlet/outlet housing an insertable large diameter electrode filter screen with support ribs which forms a 1^{st} annulus between the spool piece and the insertable large diameter electrode filter screen and a small diameter electrode filter screen with both ends consisting of solid wall tubing in which the small diameter electrode filter screen is inserted into the 1^{st} hole and 2^{nd} hole and affixed to the 1^{st} flange and 2^{nd} flange with compression couplings, which then forms a 2^{nd} annulus between the larger diameter electrode filter screen and small diameter electrode filter screen which the annulus is filled with media to prevent arcing when the screens are attached to opposite polarities of a DC Power Source and the organic matter is flowed into the small electrode screen with the material feeder and fluids flow thru the media and thru the large filter screen allowing a DC current to flow between the small screen and the large screen and the fluids flow out the spool piece inlet/outlet, while solids remaining in the small screen are held back and pressed by means of a spike attached to a linear actuator housed within a tank to capture solids and maintain a closed system. The apparatus may also include an eductor attached to the multiple mode electrolysis filter screen, a spiked electrode attached to the linear actuator, or a plasma torch attached to the linear actuator.

FIG. 22 also provides a method for treating an organic matter comprising: providing a material feeder having an input and an output, a multiple mode electrolysis filter screen comprising: a 1^{st} non-conductive flange with a 1^{st} hole, a 1^{st} gasket, a 2^{nd} non-conductive flange with a 2^{nd} hole, a 2^{nd} gasket, a spool piece with a fluid inlet/outlet housing an insertable large diameter electrode filter screen with support ribs which forms a 1^{st} annulus between the spool piece and the insertable large diameter electrode filter screen and a small diameter electrode filter screen with both ends consisting of solid wall tubing in which the small diameter electrode filter screen is inserted into the 1^{st} hole and 2^{nd} hole and affixed to the 1^{st} flange and 2^{nd} flange with compression couplings, which then forms a 2^{nd} annulus between the larger diameter electrode filter screen and small diameter electrode filter screen which the annulus is filled with media to prevent arcing when the screens are attached to opposite polarities of a DC Power Source and the organic matter is flowed into the small electrode screen with the material feeder and fluids flow thru the media and thru the large filter screen allowing a DC current to flow between the small screen and the large screen and the fluids flow out the spool piece inlet/outlet, while solids remaining in the small screen are held back and pressed by means of a spike attached to a linear actuator housed within a tank to capture solids and maintain a closed system. The method may also include an eductor attached to the multiple mode electrolysis filter screen, a spiked electrode attached to the linear actuator, or a plasma torch attached to the linear actuator.

Offshore Wind Energy with Viper™ Riser for Green H₂

Turning now to FIGS. 23 and 24, an Offshore Wind Energy Virtual Inertia Plasma ElectrolyzeR Riser System 2400 includes an offshore wind turbine WT producing 3 Phase AC electrical power 3PACP connected to a means for converting or rectifying AC to DC for example a silicon controlled rectifier (SCR), an IGBT or a magnetohydrodynamic drive. The DC power is directly connected to a plasma electrolysis system, method and apparatus 2404 comprising an anode riser 202a and a cathode riser 202c. The risers 202a and 202c are hung from the bottom or thru the moon pool of a vessel 2402 in which the renewable power source for example a wind turbine is located topside. Each riser contains a production string 201a and 201b. Wafer electrodes 1000a and 1000c are attached to production strings 201a and 202b. Riser 202a and tubular 201a are attached to an Oxidant Tree OT and riser 202c and tubular 201c are attached to a Hydrogen Tree HT. If hydrogen and oxygen are to be split from seawater, then a reverse osmosis system would be installed onboard the vessel 2402, not shown, are a subsea reverse osmosis SSRO may be installed on the seafloor. A reverse osmosis (RO) system would not be required if chlorine gas and hydrogen are to be split from seawater. It will be understood that the RO system could be installed on the deck of the wind turbine platform.

As a result, FIG. 23 provides a Virtual Inertia Plasma ElectrolyzeR™ apparatus for producing hydrogen comprising a cathode wafer electrolysis column and an anode wafer electrolysis column in which each column comprises a non-conductive housing configured for installation within a fluid transfer device, wherein the non-conductive housing has a longitudinal axis aligned with the fluid transfer device, a first opening aligned with the longitudinal axis, and a second opening aligned with the longitudinal axis and opposite the first opening. The cathode wafer electrolysis column comprises at least one cathode wafer screen assembly comprising an electrically conductive screen attached to the non-conductive housing and disposed proximate to the first opening of the housing and substantially perpendicular to the longitudinal axis and a second electrically conductive screen attached to the non-conductive housing and disposed proximate to the second opening of the housing and substantially perpendicular to the longitudinal axis, wherein the second electrically conductive screen is separated from the first electrically conductive screen by a substantially equidistant gap and a non-conductive granular material disposed within the substantially equidistant gap and a first electrical circuit breaker electrically connected to the first electrically conductive screen and the second electrically conductive screen. The anode wafer electrolysis column comprises at least two anode wafer screen assemblies comprising an electrically conductive screen attached to the non-conductive housing and disposed proximate to the first opening of the housing and substantially perpendicular to the longitudinal axis and a second electrically conductive screen attached to the non-conductive housing and disposed proximate to the second opening of the housing and substantially perpendicular to the longitudinal axis, wherein the second electrically conductive screen is separated from the first electrically conductive screen by a substantially equidistant gap and a non-conductive granular material disposed within the substantially equidistant gap and a first electrical circuit breaker electrically connected to the first electrically conductive wafer screen assembly and the second anode wafer screen assembly is attached to a second electrical circuit breaker. Plasma Electrolysis (PE) is created whenever the cathode waver assembly circuit breaker is closed and both anode wafer circuit breakers are closed and connected to an electrical power supply such that the cathode column has a negative polarity, and the anode column has a positive polarity, and an electrically conductive fluid is introduced into the cathode wafer column and the anode wafer column. Faraday Electrolysis (PE) is created whenever the cathode waver assembly circuit breaker is closed and one anode wafer circuit breaker is closed and one anode wafer circuit breaker is opened and connected to an electrical power supply such that the cathode column has a negative polarity, and the anode column has a positive polarity, and an electrically conductive fluid is introduced into the cathode wafer column and the anode wafer column.

FIG. 23 also provides a virtual inertia plasma electrolysis method for producing hydrogen comprising a cathode wafer electrolysis column and an anode wafer electrolysis column in which each column comprises a non-conductive housing configured for installation within a fluid transfer device, wherein the non-conductive housing has a longitudinal axis aligned with the fluid transfer device, a first opening aligned with the longitudinal axis, and a second opening aligned with the longitudinal axis and opposite the first opening. The cathode wafer electrolysis column comprises at least one cathode wafer screen assembly comprising an electrically conductive screen attached to the non-conductive housing and disposed proximate to the first opening of the housing and substantially perpendicular to the longitudinal axis and a second electrically conductive screen attached to the non-conductive housing and disposed proximate to the second opening of the housing and substantially perpendicular to the longitudinal axis, wherein the second electrically conductive screen is separated from the first electrically conductive screen by a substantially equidistant gap and a non-conductive granular material disposed within the substantially equidistant gap and a first electrical circuit breaker electrically connected to the first electrically conductive screen and the second electrically conductive screen. The anode wafer electrolysis column comprises at least two anode wafer screen assemblies comprising an electrically conductive screen attached to the non-conductive housing and disposed proximate to the first opening of the housing and substantially perpendicular to the longitudinal axis and a second electrically conductive screen attached to the non-conductive housing and disposed proximate to the second opening of the housing and substantially perpendicular to the longitudinal axis, wherein the second electrically conductive screen is separated from the first electrically conductive screen by a substantially equidistant gap and a non-conductive granular material disposed within the substantially equidistant gap and a first electrical circuit breaker electrically connected to the first electrically conductive wafer screen assembly and the second anode wafer screen assembly is attached to a second electrical circuit breaker. Plasma Electrolysis (PE) is created whenever the cathode waver assembly circuit breaker is closed and both anode wafer circuit breakers are closed and connected to an electrical power supply such that the cathode column has a negative polarity, and the anode column has a positive polarity, and an electrically conductive fluid is introduced into the cathode wafer column and the anode wafer column. Faraday Electrolysis (PE) is created whenever the cathode waver assembly circuit breaker is closed and one anode wafer circuit breaker is closed and one anode wafer circuit breaker is opened and connected to an electrical power supply such that the cathode column has a negative polarity, and the anode column has a positive polarity, and an electrically conductive fluid is introduced into the cathode wafer column and the anode wafer column.

Now referring to FIG. 24, it resembles FIG. 23 except the risers 202a and 202c are actually flexible pipe or hose. Coiled tubing may also be used for risers 202a and 202c. The coil or flexible hose eliminates the issue of lowering risers through a moon pool using a drilling rig configuration.

In previous testing, a boiling media such as proppants used to fracture a well, gravel or any non-conductive material, which will increase surface area, was added to the present inventor's patented glow discharge plasma electrolysis cell. The cell was operated with and without media. Testing proved that the media increased efficiency by 13%. Hence, whether operated in Plasma Electrolysis mode or Faraday Electrolysis mode, the media increase efficiency which increases hydrogen production per unit of power used within the electrolysis reactor.

Current oil and gas barges, deep water drilling ships and semisubmersible vessel equipment can be used for carrying out the present invention. For example, if a subsea reverse osmosis SSRO system is used, then the deepwater drilling ship would lower the SSRO and the risers. The risers then could be connected to a separate vessel 2402, which incorporates the renewable power source. The risers 202a and 202c would be interconnected via piping from the SSRO in order to flow pressurized deionized water to each riser. The following operating steps will demonstrate the industrial application as well as its novelty, uniqueness and obviousness.

Plasma Electrolysis Startup Mode

Riser Valves and Production String Valves integrated into the Oxidant Tree OT and Hydrogen Tree HT are opened.

DI water is flowed from the SSRO and into the risers 202a and 202c, until DI water flows out of Riser Tree OT and HT Riser Valves and Production String Valves.

SSRO DI water is diverted away from Risers 202a and 202c.

Riser Valves are shut.

High pressure Nitrogen is pumped into both production strings 201a and 201c to form a bubble on top of the water within the production strings 201a and 202c.

DC power is energized to both electrodes 200a and 200c.

As pressure increases in both the risers and production strings, Production String Valves are throttled to flow the nitrogen and then the oxidant and hydrogen into the OT and HT production strings 201a and 201c.

Plasma Electrolysis Operating Mode

DI flow is resumed to Risers 202a and 202c.

Oxidant Pressure and Hydrogen Pressure are monitored and maintained by throttling production string valves and diverting DI from the SSRO system.

Hydrostatic pressure provides the means for pressurizing the hydrogen. Thus, a separate hydrogen compressor is not needed for carrying out the present invention. Likewise, the hydrogen can be injected into natural gas (NG) pipelines for distribution of hydrogen enriched natural gas (HENG). NG pipelines are commonplace throughout the Gulf Of Mexico (GOM) and the North Sea, which are also high wind rated areas.

As a result, FIG. 24 provides an Offshore Wind Turbine Powered Virtual Inertia Plasma ElectrolyzeR™ apparatus for producing hydrogen comprising a cathode wafer electrolysis column installed within a riser hung below the deck of an offshore wind turbine platform and an anode wafer electrolysis column installed within a riser hung below the deck of an offshore wind turbine platform in which each column comprises a non-conductive housing configured for installation within a fluid transfer device, wherein the non-conductive housing has a longitudinal axis aligned with the fluid transfer device, a first opening aligned with the longitudinal axis, and a second opening aligned with the longitudinal axis and opposite the first opening. The cathode wafer electrolysis column comprises at least one cathode wafer screen assembly comprising an electrically conductive screen attached to the non-conductive housing and disposed proximate to the first opening of the housing and substantially perpendicular to the longitudinal axis and a second electrically conductive screen attached to the non-conductive housing and disposed proximate to the second opening of the housing and substantially perpendicular to the longitudinal axis, wherein the second electrically conductive screen is separated from the first electrically conductive screen by a substantially equidistant gap and a non-conductive granular material disposed within the substantially equidistant gap and a first electrical circuit breaker electrically connected to the first electrically conductive screen and the second electrically conductive screen. The anode wafer electrolysis column comprises at least two anode wafer screen assemblies comprising an electrically conductive screen attached to the non-conductive housing and disposed proximate to the first opening of the housing and substantially perpendicular to the longitudinal axis and a second electrically conductive screen attached to the non-conductive housing and disposed proximate to the second opening of the housing and substantially perpendicular to the longitudinal axis, wherein the second electrically conductive screen is separated from the first electrically conductive screen by a substantially equidistant gap and a non-conductive granular material disposed within the substantially equidistant gap and a first electrical circuit breaker electrically connected to the first electrically conductive wafer screen assembly and the second anode wafer screen assembly is attached to a second electrical circuit breaker. Plasma Electrolysis (PE) is created whenever the cathode waver assembly circuit breaker is closed and both anode wafer circuit breakers are closed and connected to an electrical power supply such that the cathode column has a negative polarity, and the anode column has a positive polarity, and an electrically conductive fluid is introduced into the cathode wafer column and the anode wafer column. Faraday Electrolysis (PE) is created whenever the cathode waver assembly circuit breaker is closed and one anode wafer circuit breaker is closed and one anode wafer circuit breaker is opened and connected to an electrical power supply such that the cathode column has a negative polarity, and the anode column has a positive polarity, and an electrically conductive fluid is introduced into the cathode wafer column and the anode wafer column.

Referring to FIG. 25 while also referring to FIGS. 9 and 10, the wafer style plasma electrolysis apparatuses are installed in a conduit or pipe in which water enters the conduit or pipe via an inlet/outlet. The water rises in the conduit and comes in contact with a 1^{st} electrically conductive wafer screen assembly with a 1^{st} polarity and a 2^{nd} electrically conductive wafer screen assembly with a 2^{nd} polarity. It will be understood that the 1^{st} and 2^{nd} polarities are opposite of one another. For example, the cathode wafer would be powered by the negative side of a DC power source and the anode wafer would be powered by the positive side of the DC power source.

The configuration of FIG. 25 allows for electrolysis production of hydrogen on the 1^{st} electrically conductive wafer screen assembly and oxygen or oxidants on the 2^{nd} electrically conductive wafer screen assembly. Fluid is flowed into the inlet/outlet via a control valve and comes into contact with both screen assemblies. The fluid is converted to hydrogen on the cathode screen assembly and oxygen or oxidants on the anode screen assembly. The effluent from each screen recombine and are flowed back into the conduit or a receiving tank. A fluid sensor monitors conditions such as total dissolved solids (TDS), total suspended solids (TSS), pH, temperature, ORP, and other known parameters to control the quality of the fluid within the conduit by opening, shutting or throttling the control valve.

To transition from electrolysis to plasma electrolysis only one screen on the 1^{st} electrically conductive wafer screen assembly which is the cathode would be energized with a circuit breaker (not shown). The other screen on the 1^{st} electrically conductive wafer screen assembly would be electrically isolated via a circuit breaker or any means known in the art such as simply disconnecting a power lead.

As a result, FIG. 25 provides an Offshore Wind Turbine Powered Virtual Inertia Plasma ElectrolyzeR™ apparatus for producing hydrogen comprising a cathode wafer electrolysis column installed below or near an offshore wind turbine platform and attached to the platform via flexible tubing and an anode wafer electrolysis column installed below or near an offshore wind turbine platform and attached to the platform via flexible tubing in which each column comprises a non-conductive housing configured for installation within a fluid transfer device, wherein the non-conductive housing has a longitudinal axis aligned with the fluid transfer device, a first opening aligned with the longitudinal axis, and a second opening aligned with the longitudinal axis and opposite the first opening. The cathode wafer electrolysis column comprises at least one cathode wafer screen assembly comprising an electrically conductive screen attached to the non-conductive housing and disposed proximate to the first opening of the housing and substantially perpendicular to the longitudinal axis and a second electrically conductive screen attached to the non-conductive housing and disposed proximate to the second opening of the housing and substantially perpendicular to the longitudinal axis, wherein the second electrically conductive screen is separated from the first electrically conductive screen by a substantially equidistant gap and a non-conductive granular material disposed within the substantially equidistant gap and a first electrical circuit breaker electrically connected to the first electrically conductive screen and the second electrically conductive screen. The anode wafer electrolysis column comprises at least two anode wafer screen assemblies comprising an electrically conductive screen attached to the non-conductive housing and disposed proximate to the first opening of the housing and substantially perpendicular to the longitudinal axis and a second electrically conductive screen attached to the non-conductive housing and disposed proximate to the second opening of the housing and substantially perpendicular to the longitudinal axis, wherein the second electrically conductive screen is separated from the first electrically conductive screen by a substantially equidistant gap and a non-conductive granular material disposed within the substantially equidistant gap and a first electrical circuit breaker electrically connected to the first electrically conductive wafer screen assembly and the second anode wafer screen assembly is attached to a second electrical circuit breaker. Plasma Electrolysis (PE) is created whenever the cathode waver assembly circuit breaker is closed and both anode wafer circuit breakers are closed and connected to an electrical power supply such that the cathode column has a negative polarity, and the anode column has a positive polarity, and an electrically conductive fluid is introduced into the cathode wafer column and the anode wafer column. Faraday Electrolysis (PE) is created whenever the cathode waver assembly circuit breaker is closed and one anode wafer circuit breaker is closed and one anode wafer circuit breaker is opened and connected to an electrical power supply such that the cathode column has a negative polarity, and the anode column has a positive polarity, and an electrically conductive fluid is introduced into the cathode wafer column and the anode wafer column.

FIG. 26 discloses the similar system, method and apparatus of FIG. 25 accept fluid is first introduced into either the 1^{st} or 2^{nd} electrically conductive wafer screen assemblies or both electrically conductive wafer screen assemblies. The fluid blowdown would be controlled with the sensor operating the control valve.

A Virtual Inertia Plasma ElectrolyzeR™ apparatus for producing hydrogen comprises a cathode wafer electrolysis column and an anode wafer electrolysis column in which each column comprises a non-conductive housing configured for installation within a fluid transfer device, wherein each column has a non-conductive housing, a longitudinal axis aligned with the fluid transfer device, a first opening aligned with the longitudinal axis, and a second opening aligned with the longitudinal axis and opposite the first opening. The cathode wafer electrolysis column comprises at least one cathode wafer screen assembly comprising an electrically conductive screen attached to the non-conductive housing and disposed proximate to the first opening of the housing and substantially perpendicular to the longitudinal axis and a second electrically conductive screen attached to the non-conductive housing and disposed proximate to the second opening of the housing and substantially perpendicular to the longitudinal axis, wherein the second electrically conductive screen is separated from the first electrically conductive screen by a substantially equidistant gap and a non-conductive granular material disposed within the substantially equidistant gap and a DC power source is electrically connected to both screens of the cathode wafer screen. The anode wafer electrolysis column comprises at least two anode wafer screen assemblies comprising an electrically conductive screen attached to the non-conductive housing and disposed proximate to the first opening of the housing and substantially perpendicular to the longitudinal axis and a second electrically conductive screen attached to the non-conductive housing and disposed proximate to the second opening of the housing and substantially perpendicular to the longitudinal axis, wherein the second electrically conductive screen is separated from the first electrically conductive screen by a substantially equidistant gap and a non-conductive granular material disposed within the substantially equidistant gap and a DC power source is electrically connected to both screens of the cathode wafer screen. The cathode wafer column and the anode wafer column are connected via a common pipe or conduit wherein the conduit has an inlet/outlet. Plasma Electrolysis (PE) is created when an electrically conductive fluid is introduced into the inlet/outlet and contacts the cathode wafer screens and the anode wafer screens.

FIG. 27 is very similar to FIGS. 25 and 26. Additional 2^{nd} electrically conductive screen assemblies are installed and used as anodes and powered via the positive side of a DC power source. This system, method and apparatus allows for increased surface area on the anode electrode screen assembly as compared to the surface area of the cathode electrode screen assembly. Consequently, this allows for continuous operation in glow discharge aka plasma electrolysis mode.

A Virtual Inertia Plasma ElectrolyzeR™ apparatus for producing hydrogen comprises a cathode wafer electrolysis column and an anode wafer electrolysis column in which each column comprises a non-conductive housing configured for installation within a fluid transfer device, wherein each column has a non-conductive housing, a longitudinal axis aligned with the fluid transfer device, a first opening aligned with the longitudinal axis, and a second opening aligned with the longitudinal axis and opposite the first opening. The cathode wafer electrolysis column comprises at least one cathode wafer screen assembly comprising an electrically conductive screen attached to the non-conductive housing and disposed proximate to the first opening of the housing and substantially perpendicular to the longitudinal axis and a second electrically conductive screen attached to the non-conductive housing and disposed proximate to the second opening of the housing and substantially perpendicular to the longitudinal axis, wherein the second electrically conductive screen is separated from the first electrically conductive screen by a substantially equidistant gap and a non-conductive granular material disposed within the substantially equidistant gap and a DC power source is electrically connected to both screens of the cathode wafer screen. The anode wafer electrolysis column comprises at least one anode wafer screen assemblies comprising an electrically conductive screen attached to the non-conductive housing and disposed proximate to the first opening of the housing and substantially perpendicular to the longitudinal axis and a second electrically conductive screen attached to the non-conductive housing and disposed proximate to the second opening of the housing and substantially perpendicular to the longitudinal axis, wherein the second electrically conductive screen is separated from the first electrically conductive screen by a substantially equidistant gap and a non-conductive granular material disposed within the substantially equidistant gap and a DC power source is electrically connected to both screens of the cathode wafer screen. The cathode wafer column and the anode wafer column are connected via a common pipe or conduit wherein the conduit has an inlet/outlet. Plasma Electrolysis (PE) is created when an electrically conductive fluid is introduced into either the top of the cathode wafer screens or the anode wafer screens or introduced into both the cathode wafer screens and the anode wafer screens. The apparatus may also include a sensor, control valve, two or more anode wafer screen assemblies, or diffuser. The cathode column can be higher in elevation than the anode column.

Carbon Dioxide (CO₂) Capture and Reduction to Carbon Monoxide (CO) for Zero Carbon Emissions

In previous testing baking soda (sodium bicarbonate) was used as an electrolyte by addition to drinking water. The sodium bicarbonate was converted to sodium carbonate (NaOH) commonly referred to as caustic soda.

This gives rise to a system for capturing carbon as carbon dioxide and then reducing it to carbon monoxide for use as a chemical feedstock. Referring to FIG. 28 a fine bubble diffuser is installed within the cathode screen side of the conduit or pipe. Not being bound by theory, as carbon dioxide bubbles rise and contact the cathode screen, the carbon dioxide will be reduced to carbon monoxide via a synergistic effect with plasma electrolysis and not just via hydrogen reduction. In addition, excess hydrogen will be produced thus giving rise to green syngas for use as a green chemical feedstock.

For a zero emission closed CO₂ cycle, the CO₂ would be captured with the caustic soda produced from any of the systems, methods and apparatuses of the present invention. Consequently, this gives rise to a system, method and apparatus for capturing carbon from point source emissions or direct air capture, then converting the CO₂ to CO while also regenerating the spent caustic and returning it to the point source emission or direct air capture system.

FIG. 29 discloses a system for a linear plasma electrolysis wafer assembly in which the distance between the two screens is extended and additional media is added to a conduit or pipe housing the screen assemblies. However, to ensure that less screen area is exposed to fluid for the cathode or 1^{st} electrically conductive screen assembly a weir flange is housed between the 1^{st} electrically conductive screen assembly and the conduit or pipe. The weir retards or holds back fluid thus allowing only a small amount of fluid to contact the 1^{st} electrically conductive screen assembly as opposed to the 2^{nd} electrically conductive screen assembly. It will be understood that the fluid exiting from both screens would be recombined and recycled to the inlet or to a tank (not shown). As previously disclosed the media prevents arcing from one screen to the other screen. In addition, it will be understood that in lieu of a weir flange a gate valve may be installed to retard to hold back fluid.

FIG. 30 discloses the linear plasma electrolysis wafer assembly with numerous anode assemblies in lieu of a weir flange. The assembly is installed on top, on the side or near a tank, conduit, vessel or pipe. A pump pulls a suction on the tank and fluid flows into the inlet of the assembly. Fluid flows towards the cathode screen and towards the anode screen. The fluid is converted to hydrogen on the cathode screen and via plasma electrolysis and the anode screen produces oxidants. Hydrogen and liquids are separated via a 1^{st} gas liquids separator 1^{st} GLS and oxidants and liquids are separated via a 2^{nd} gas liquids separator 2^{nd} GLS. HydroCyclone separators shown as 1^{st} HC and 2^{nd} HC are ideal gas liquids separators for use within the present invention. The catholyte from the 1^{st} HC and the anolyte from the 2^{nd} HC may be remixed within the tank. However, a membrane (not shown) may be installed to keep the catholyte and anolyte separated within its respective chambers. Both liquids are remixed within the tank. As hydrogen and oxygen are produced makeup water MU can be added to the tank. Likewise, as total dissolved solids (TDS), pH, temperature and other liquid parameters change the liquid can be removed via a blowdown line.

Destruction of Nitrogen Trichloride (NCl₃) in Chlor-Alkali Plants

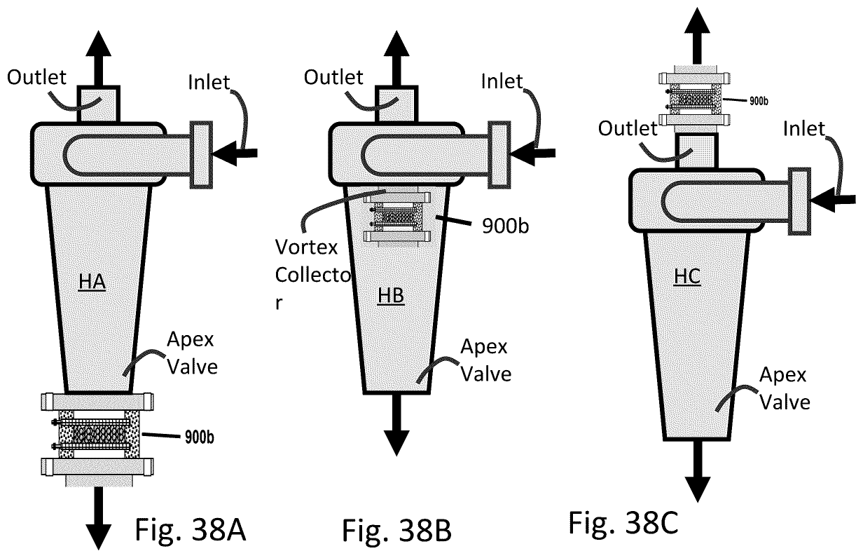

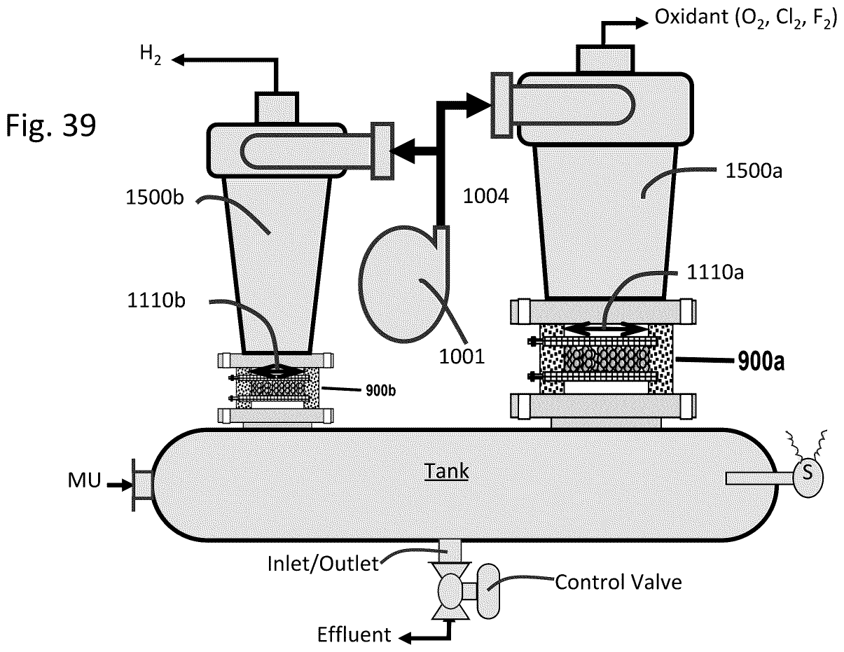

A full description for the properties of NCl₃ and its destruction with UV light can be found in the present inventor's U.S. Pat. No. 5,832,361, which is hereby incorporated by reference in its entirety. Returning back to FIGS. 30 and 31 by reversing the polarity such that the cathode screen becomes the anode screen this allows for the anode to operate in a plasma electrolysis mode. The high temperature plasma effectively destroys nitrogen trichloride (NCl₃). Consequently, this eliminates an explosion hazard within Chlor-Alkali production facilities. Likewise, this unique chlor-alkali cell can be used within the oilfield for converting produced water to chlorine and hydrogen.

A Virtual Inertia Plasma ElectrolyzeR™ apparatus for producing hydrogen comprising: an electrically non-conductive spool piece with an inlet with a first electrically conductive screen and a weir flange installed on one end of the spool piece a second electrically conductive screen assembly installed on the opposite end of the spool piece and the spool piece is filled with media to prevent arcing wherein a DC power source leads are connected to the first electrically conductive screen and the second conductive screens such that the screens are of opposite polarity and a plasma electrolysis is formed when fluid is introduced into the inlet and flows through the media and up and over the weir of the first electrically conductive screen to reduce the surface area contacted by the fluid and the fluid contacts the second the electrically conductive screen.

FIG. 32 provides a Virtual Inertia Plasma ElectrolyzeR™ apparatus for producing hydrogen comprising: an electrically non-conductive spool piece with an inlet with a first electrically conductive screen installed on one end of the spool piece and at least a second and third electrically conductive screen assemblies installed on the opposite end of the spool piece and the spool piece is filled with media to prevent arcing wherein a DC power source leads are connected to the first electrically conductive screen and the second and third conductive screens such that the screens are of opposite polarity and a plasma electrolysis is formed when fluid is introduced into the inlet and flows through the media and contacts the first electrically conductive screen and contacts the second and third electrically conductive screens that are electrically connected together as one polarity via hard wire or circuit breakers.

In one aspect, the discharge from the first electrically conductive screen is flowed into a first hydrocyclone and flowing the discharge from the second electrically conductive screen into a second hydrocyclone. In another aspect, the first hydrocyclone catholyte liquid and the second hydrocyclone anolyte liquid are flowed into a tank. In another aspect, a pump flows fluid into the virtual inertia plasma electrolyzer. In another aspect, a sensor monitors and controls parameters, such as Total Dissolved Solids (TDS), Total Suspended Solids (TDS), Oxidation Reduction Potential (ORP), Dissolved Oxygen (DO), pH, temperature and pressure. In another aspect, the apparatus includes a makeup fluid inlet, a blowdown fluid outlet, or a membrane for separating the catholyte from the anolyte.

Parameters for Plasma Electrolysis (PE) Vs Faraday Electrolysis (FE)

There are two critical parameters for transitioning from Faraday Electrolysis to Plasma Electrolysis. The first parameter is DC volts. The DC power source must provide enough voltage to transition from Faraday Electrolysis (FE) to Plasma Electrolysis (PE). However, not being bound by theory it is believed that the combination of less surface area for the desired PE electrode with sufficient voltage allows for maintaining PE Mode. This has been clearly demonstrated by the present inventor.

FIG. 33 is an exemplary description for how to build and use screens of different diameters hence different areas as measured in cm² to effectively construct a system, method and apparatus to carry out the present invention. For example, as shown in FIG. 33, to ignite, sustain and contain a plasma electrolysis mode the cathode should be smaller in diameter than the anode. Of course, if polarity is reversed than the anode would be smaller in diameter than the cathode. The configuration shown with a smaller cathode has great use as a novel plasma electrolyzer, hydrogen plasma torch and/or hydrogen oxygen burner.

A virtual inertia plasma electrolysis method comprises a first electrode wafer electrolysis screen assembly with a first surface area that its surface area is smaller than a second electrolysis screen assembly with a second surface area and installing each electrolysis screen assemblies into separate electrically non-conductive columns connected via a fluid transfer conduit and each electrolysis screen assembly is electrically connected to opposite polarities of a DC power source and a plasma electrolysis is formed when fluid is flowed into the fluid transfer conduit and the fluid contacts the first electrode wafer screen assembly and the second electrode screen assembly.

FIGS. 34A and 34B disclose plasma electrolyzers in accordance with various embodiments of the present invention. Referring to FIG. 34A an anode screen assembly is attached to a vessel containing media, a well and a tube inserted within the well. On top of the vessel or affixed to the vessel is a concentric reducer (C Reducer). A cathode screen assembly is attached to the small end of the cone. The tube protrudes thru a hole in top of the vessel and into the concentric reducer, which also houses media. It will be understood that the tube is sealed to the vessel thus not allowing any fluids to transfer thru the hole. Of course, the media is also within the tube and the well. The following steps will describe a preferred mode of operation for producing hydrogen and oxidants.

Plasma Electrolysis Mode of Operation

Large Screen Lug 1 (LSL1) is hooked up to positive side of DC Power source.

Small Screen Lug 2 (SSL2) is hooked up to negative side of DC Power source.

Turn ON Power Supply.

Shut valve attached to 1^{st} hydrocyclone.

Flow Liquid (L) thru Anode Screen Assembly and into vessel.

Liquid will then flow into the well and into the tube.

Upon liquid touching the Cathode Screen Assembly the system will be energized.

Open valve attached to 1^{st} hydrocyclone.

Cathode Screen Assembly will be in Plasma Electrolysis Mode.

O₂ and Anolyte Liquid will flow out of the vessel and into a 1^{st} Hydrocyclone.

O₂ and Anolyte Liquid will be separated in the 1^{st} Hydrocyclone.

H₂ and Catholyte Liquid will flow into a riser attached to a 2^{nd} Hydrocyclone.

H₂ and Catholyte Liquid will be separated in the 2^{nd} Hydrocyclone.

FIG. 34A provides a virtual inertia plasma electrolyzer apparatus for making and separating hydrogen from oxidants comprises: an electrically non-conductive vessel with a large surface area anode screen assembly attached to the first end of the vessel, an outlet with a valve attached to the vessel with a first hydrocyclone attached to the valve, a hole within the second end of the vessel, an electrically non-conductive tube inserted through the hole, a well in which the tube sits within, a concentric reducer attached to the second end of the vessel, a small surface area cathode screen assembly attached to the small end of the concentric reducer, a riser attached to cathode screen assembly with a second hydrocyclone attached to the riser, a media filling the vessel, well, tube and concentric reducer, and the cathode screen is attached to the negative side of a DC power source and the anode is connected to the positive side of a DC power source and a plasma electrolysis is formed when liquid flows into the vessel, into the well, up into the tube and comes in contact with the cathode screen.

FIG. 34B discloses a very similar system, method and apparatus as shown in FIG. 34A. However, the concentric reducer is removed and the Cathode Screen Assembly is simply attached directly to the tube protruding thru the vessel. Once again, the tube is sealed to the housing.

FIG. 34B provides a virtual inertia plasma electrolyzer apparatus for making and separating hydrogen from oxidants comprising: an electrically non-conductive vessel with a large surface area anode screen assembly attached to the first end of the vessel, an outlet with a valve attached to the vessel with a first hydrocyclone attached to the valve, a hole within the second end of the vessel, an electrically non-conductive tube inserted through the hole, a well in which the tube sits within, a small surface area cathode screen assembly attached to the electrically non-conductive tube, a riser attached to the cathode screen assembly with a second hydrocyclone attached to the riser, a media filling the vessel, well, tube and concentric reducer, and the cathode screen is attached to the negative side of a DC power source and the anode is connected to the positive side of a DC power source and a plasma electrolysis is formed when liquid flows into the vessel, into the well, up into the tube and comes in contact with the cathode screen.

Plasma Electrolysis Torch

While referring back to FIGS. 9, 10 and 11, the systems disclosed in FIGS. 35A, 35B and 35C are for use as a steam plasma torch, steam plasma reformer, plasma burner or thermal oxidizer. For example, referring to FIG. 34A an anode screen assembly is attached to a vessel with a concentric reducer (C Reducer). The vessel is filled with media. A cathode screen assembly is attached to the small end of the cone. Not being bound by theory, the system, method and apparatus can be operated in various modes:

Vertical Steam Plasma Electrolysis Mode of Operation FIG. 35A

Large Screen Lug 1 (LSL1) is hooked up to positive side of DC Power source.

Small Screen Lug 2 (SSL2) is hooked up to negative side of DC Power source.

Turn ON Power Supply.

Flow Liquid (L) thru Anode Screen Assembly and into vessel.

Liquid will then rise and upon touching the Cathode Screen Assembly the system will be energized.

Cathode Screen Assembly will be in Plasma Electrolysis Mode.

O₂ will be generated on the Anode Screen Assembly.

O₂ will and come in contact with the plasma and H₂ generated on the cathode screen assembly.

The Plasma will ignite the H₂+O₂ forming a steam plasma.

FIG. 35A provides a virtual inertia plasma electrolyzer torch apparatus comprising: an electrically non-conductive vessel with a concentric reducer, a large surface area electrically conductive screen assembly attached to the large end of the vessel, a small surface area electrically conductive screen assembly attached to the small end of the concentric reducer, a media filling the vessel and the concentric reducer, a DC power source with one lead connected to the small electrically conductive screen and the other lead of opposite polarity is connected to the large electrically conductive screen and a plasma electrolysis is formed when the DC power source is energized and liquid flows thru the large electrically conductive screen, thru the media and comes in contact with the small electrically conductive screen.

Horizontal Plasma Electrolysis Mode of Operation FIG. 35B with Eccentric Reducer

Large Screen Lug 1 (LSL1) is hooked up to positive side of DC Power source.

Small Screen Lug 2 (SSL2) is hooked up to negative side of DC Power source.

Turn ON Power Supply.

Flow Liquid (L) thru Anode Screen Assembly and into vessel.

Liquid will progress thru media and upon touching the Cathode Screen Assembly the system will be energized.

Cathode Screen Assembly will be in Plasma Electrolysis Mode.

O₂ will be generated on the Anode Screen Assembly.

O₂ will be swept along with liquid and come in contact with the plasma and H₂ generated on the cathode screen assembly.

The Plasma will ignite the H₂+O₂ forming a steam plasma.

FIG. 35B provides a virtual inertia plasma electrolyzer torch apparatus comprising: an electrically non-conductive vessel with an eccentric reducer, a large surface area electrically conductive screen assembly attached to the large end of the vessel, a small surface area electrically conductive screen assembly attached to the small end of the eccentric reducer, a media filling the vessel and the eccentric reducer, a DC power source with one lead connected to the small electrically conductive screen and the other lead of opposite polarity is connected to the large electrically conductive screen and a plasma electrolysis is formed when the DC power source is energized and liquid flows thru the large screen, thru the media and comes in contact with the small electrically conductive screen.

Horizontal Plasma Electrolysis Mode of Operation FIG. 35C with Inverted Eccentric Reducer

Large Screen Lug 1 (LSL1) is hooked up to positive side of DC Power source.

Small Screen Lug 2 (SSL2) is hooked up to negative side of DC Power source.

Turn ON Power Supply.

Flow Liquid (L) thru Anode Screen Assembly and into vessel.

Liquid will progress thru media and upon touching the Cathode Screen Assembly the system will be energized.

Cathode Screen Assembly will be in Plasma Electrolysis Mode.

O₂ will be generated on the Anode Screen Assembly.

O₂ will collect on the top and flow into a riser.

The O₂ can be throttled with a valve.

Some O₂ will be swept along with liquid and come in contact with the plasma and H₂ generated on the cathode screen assembly.

The Plasma will ignite the H₂+O₂ forming a steam plasma or a steam and H₂ plasma, based upon how much O₂ is vented via the valve.

FIG. 35C provides a virtual inertia plasma electrolyzer torch apparatus comprising: an electrically non-conductive vessel with an eccentric reducer, a large surface area electrically conductive screen assembly attached to the large end of the vessel, a small surface area electrically conductive screen assembly attached to the small end of the eccentric reducer, a media filling the vessel and the eccentric reducer, a riser attached to the non-conductive vessel, a valve attached to the riser, a DC power source with one lead connected to the small electrically conductive screen and the other lead of opposite polarity is connected to the large electrically conductive screen and a plasma electrolysis is formed when the DC power source is energized and liquid flows thru the large screen, thru the media and comes in contact with the small electrically conductive screen.

FIG. 36 discloses a large anode screen assembly 900a with a first diameter shown by arrow 1110a and a small cathode screen assembly 900b with a second diameter shown by arrow 1110b installed within a tank. Liquid L enters the tank via an inlet.

Plasma Electrolysis Mode of Operation

Large Anode Screen Assembly 900a is hooked up to positive side of DC Power source.

Small Cathode Screen Assembly 900b is hooked up to negative side of DC Power source.

Turn ON Power Supply.

Flow Liquid (L) into tank via an inlet.

As tank fills liquid will contact the Anode Screen 900a.

As tank continue to fill liquid will contact Cathode Screen 900b.

System will now be in Plasma Electrolysis (PE) Mode.

Oxidants and Anolyte will flow out of the Large Anode Screen Assembly 900a.

H₂ and Catholyte will flow out of the Small Cathode Screen Assembly 900b.

FIG. 36 provides a virtual inertia plasma electrolysis method comprising: a first electrode wafer electrolysis screen assembly with a first surface area that its surface area is smaller than a second electrolysis screen assembly with a second surface area and installing each electrolysis screen assembly inside a tank with an inlet and each electrolysis screen assembly is electrically connected to opposite polarities of a DC power source and a plasma electrolysis is formed when fluid flows thru the inlet and into the tank and into each wafer electrolysis screen assembly.

FIG. 37 is similar to FIG. 36 except the screen assemblies are place on the outside of the tank. In addition, an eductor 1200 is attached to the tank in order to pull a suction on a recirculation line. The recirculation line would be attached to the liquid anolyte and liquid catholyte discharged from their respective electrode screen assemblies.

FIG. 37 provides a virtual inertia plasma electrolysis apparatus comprising: a first electrode wafer electrolysis screen assembly with a first surface area that its surface area is smaller than a second electrolysis screen assembly with a second surface area and both wafer electrolysis screen assemblies are attached to a tank, pipe or vessel, and each electrolysis screen assembly is electrically connected to opposite polarities of a DC power source and a plasma electrolysis is formed when fluid flows thru the inlet and into the tank and into each wafer electrolysis screen assembly.

In one aspect, an eductor is attached to the tank. In another aspect, the apparatus includes a suction line for recirculating anolyte, catholyte, injecting fluids into the tank or any combination thereof. In another aspect, an inlet/outlet line is attached to the tank. In another aspect, a control valve is attached to the inlet/outlet. In another aspect, the apparatus includes a sensor for monitoring parameters such as TDS, TSS, pH, ORP, DO, Temperature and Pressure.

FIGS. 38A, 38B and 37C disclose systems for retrofitting a hydrocyclone into a plasma electrolysis hydrocyclone. As disclosed in FIG. 38A the electrode screen assembly of FIG. 9 would be installed as the vortex valve of a hydrocyclone. FIG. 38B shows FIG. 9 installed the vortex collector entry of a hydrocyclone. FIG. 38C discloses the electrode screen assembly 900b attached to the vortex collector exit of the hydrocyclone. It will be understood that one or more electrode screen assemblies could be installed on the same hydrocyclone. The plasma electrolysis hydrocyclone system, method and apparatus disclosed herein gives rise to a unique, unobvious, and novel process intensification method for synergistically combining solid, liquid and gas separation with electrolysis.

FIG. 38A provides a plasma electrolysis hydrocyclone apparatus comprising: a wafer electrolysis screen assembly attached to the apex valve of the hydrocyclone and the wafer electrolysis screen assembly comprising: a first electrical conductive screen and a second electrolysis screen assembly separated with an electrically non-conductive body, and the first electrically conductive screen and the second electrically conductive screen are electrically connected to opposite polarities of a DC power source and a plasma electrolysis is formed when fluid flows into the hydrocyclone and thru the wafer electrolysis screen assembly.

FIG. 38B provides a plasma electrolysis hydrocyclone apparatus comprising: a wafer electrolysis screen assembly attached to the vortex collector inside the hydrocyclone and the wafer electrolysis screen assembly comprising: a first electrical conductive screen and a second electrolysis screen assembly separated with an electrically non-conductive body, and the first electrically conductive screen and the second electrically conductive screen are electrically connected to opposite polarities of a DC power source and a plasma electrolysis is formed when fluid flows into the hydrocyclone and thru the wafer electrolysis screen assembly attached to the vortex collector.

FIG. 38C provides a plasma electrolysis hydrocyclone apparatus comprising: a wafer electrolysis screen assembly attached to outlet of the hydrocyclone and the wafer electrolysis screen assembly comprising: a first electrical conductive screen and a second electrolysis screen assembly separated with an electrically non-conductive body, and the first electrically conductive screen and the second electrically conductive screen are electrically connected to opposite polarities of a DC power source and a plasma electrolysis is formed when fluid flows into the hydrocyclone and thru the wafer electrolysis screen assembly attached to the outlet of the hydrocyclone.

FIG. 39 is a dual plasma electrolysis hydrocyclone system for making hydrogen and oxidants while separating the hydrogen and oxidants under pressure and recombining the anolyte and catholyte into a common tank. The system includes a large hydrocyclone 1500a containing a large anode screen assembly. Likewise, a separate smaller hydrocyclone 1500b contains a small cathode screen assembly. A pump is 1001 is connected to a fluid line 1004 that flows liquid into both hydrocyclones. It will be understood that the hydrocyclones may be the same size, but more anode screen assembly hydrocyclones would be installed to give a larger anode screen surface area. Or screens may be stacked as disclosed earlier. The dual electrolysis hydrocyclone system will now be described in it best operating mode:

Plasma Electrolysis Mode of Operation

Hook up Large Anode Screen Assembly 900a housed within the Large Hydrocyclone 1500a to the positive side of a DC Power source.

Hook up Small Cathode Screen Assembly 900b housed within the Small Hydrocyclone 1500b to the negative side of a DC Power source.

DC Power Supply Energizied.

Pump 1001 turned ON.

Liquid flows into both hydrocyclones via line 1004.

As the liquid contacts both screens current will flow and a plasma will from on the small cathode screen assembly 900b.

Hydrogen will exit from the vortex collector of the small hydrocyclone 1500b.

Catholyte will exit from the bottom of the small hydrocyclone 1500b.

Oxidants will exit from the large vortex collector of the large hydrocyclone 1500a.

Anolyte will exit from the bottom of the large hydrocyclone 1500a.

Anolyte and catholyte will be mixed within the tank.

H₂ and Catholyte will flow out of the Small Cathode Screen Assembly 900b.

System is monitored with a Sensor S.

S controls both makeup water and blowdown.

DC Source monitors and controls amps and volts to maintain plasma electrolysis mode.

FIG. 39 provides a Dual Plasma Electrolysis Hydrocyclone apparatus for producing hydrogen and oxidants comprising: a tank, pipe or conduit, a first large hydrocyclone containing a large plasma electrolysis wafer screen assembly attached to the apex valve of the large hydrocyclone which is attached to the tank, a second small hydrocyclone containing a small plasma electrolysis wafer screen assembly attached to the apex valve of the small second hydrocyclone attached to the tank and the large plasma electrolysis wafer screen assembly and the small electrolysis wafer screen assembly are electrically connected to opposite polarities of a DC power source and a plasma electrolysis is formed when fluid flows into both hydrocyclones and thru both electrolysis wafer screen assemblies.

In one aspect, the apparatus includes a pump for flowing fluid into the hydrocyclones. In another aspect, the apparatus includes an inlet/outlet line with a control valve attached to the inlet/outlet line. In another aspect, a makeup inlet line flows additional fluid into the tank. In another aspect, a sensor monitors parameters such, as TDS, TSS, pH, ORP, DO, Temperature and Pressure. In another aspect, the apparatus includes a membrane for separating the anolyte from the catholyte.

FIG. 39 also provides a Dual Plasma Electrolysis Hydrocyclone method for producing hydrogen and oxidants comprising: a tank, pipe or conduit, a first large hydrocyclone containing a large plasma electrolysis wafer screen assembly attached to the apex valve of the large hydrocyclone which is attached to the tank, a second small hydrocyclone containing a small plasma electrolysis wafer screen assembly attached to the apex valve of the small second hydrocyclone attached to the tank and the large plasma electrolysis wafer screen assembly and the small electrolysis wafer screen assembly are electrically connected to opposite polarities of a DC power source and a plasma electrolysis is formed when fluid flows into both hydrocyclones and thru both electrolysis wafer screen assemblies.

In one aspect, the apparatus includes a pump for flowing fluid into the hydrocyclones. In another aspect, the apparatus includes an inlet/outlet line with a control valve attached to the inlet/outlet line. In another aspect, a makeup inlet line flows additional fluid into the tank. In another aspect, a sensor monitors parameters such, as TDS, TSS, pH, ORP, DO, Temperature and Pressure. In another aspect, the apparatus includes a membrane for separating the anolyte from the catholyte.

Although preferred embodiments of the present invention have been described in detail, it will be understood by those skilled in the art that various modifications can be made therein without departing from the spirit and scope of the invention as set forth in the appended claims.

What is claimed is:

1. An insertable plasma electrolysis apparatus comprising:
a first non-conductive plate having a first outlet and a second outlet;
a first cylindrical conductive screen extending below the first non-conductive plate proximate to the first outlet such that a inner diameter of the first cylindrical conductive screen is greater than or equal to an inner diameter of the first outlet;
a cylindrical non-conductive tube extending below the first non-conductive plate such that the cylindrical non-conductive tube is disposed around the first cylindrical conductive screen with a first substantially equidistant gap between the first cylindrical conductive screen and the cylindrical non-conductive tube;
a second cylindrical conductive screen extending below the first non-conductive plate such that the second cylindrical conductive screen is disposed around the cylindrical non-conductive tube with a second substantially equidistant gap between the cylindrical non-conductive tube and the second cylindrical conductive screen;
the second outlet is either disposed between the cylindrical non-conductive tube and the second cylindrical conductive screen or outside of the second cylindrical conductive screen;
a first electrical terminal coupled to the first cylindrical conductive screen;
a second electrical terminal coupled to the second cylindrical conductive screen; and
wherein a length of the first cylindrical conductive screen is less that a length of the second cylindrical conductive screen, and a length of the cylindrical non-conductive tube is greater than the length of the second cylindrical conductive screen.

2. The insertable plasma electrolysis apparatus as recited in claim 1, wherein the apparatus is configured to be inserted into a vessel, pipe, conduit, column, tank, well or any structure that holds a fluid to form a closed system.

3. The insertable plasma electrolysis apparatus as recited in claim 1, wherein the first cylindrical conductive screen comprises a cathode and the second cylindrical conductive screen comprises an anode.

4. The insertable plasma electrolysis apparatus as recited in claim 1, wherein the first cylindrical conductive screen is substantially aligned with a longitudinal axis of the first outlet.

5. The insertable plasma electrolysis apparatus as recited in claim 1, wherein the first outlet and the second outlet extend above a top of the first non-conductive plate.

6. The insertable plasma electrolysis apparatus as recited in claim 5, wherein:
the first electrical terminal is connected to the first outlet, and the first outlet is electrically conductive and attached to the first cylindrical conductive screen; and
the second electrical terminal is connected to the second outlet, and the second outlet is electrically conductive and attached to the second cylindrical conductive screen.

7. The insertable plasma electrolysis apparatus as recited in claim 1, further comprising a second non-conductive plate attached above or below the first non-conductive plate.

8. The insertable plasma electrolysis apparatus as recited in claim 7, wherein the first cylindrical conductive screen is attached to the second non-conductive plate.

9. The insertable plasma electrolysis apparatus as recited in claim 7, wherein the cylindrical non-conductive tube is attached to the second non-conductive plate.

10. The insertable plasma electrolysis apparatus as recited in claim 7, wherein the second cylindrical conductive screen is attached to the second non-conductive plate.

11. The insertable plasma electrolysis apparatus as recited in claim 1, wherein the cylindrical non-conductive tube comprises a third cylindrical non-conductive tube, and further comprising:
a first cylindrical non-conductive tube attached to a bottom of the first cylindrical conductive screen or an extension of the first cylindrical conductive screen that is coated with a non-conductive material;
a second cylindrical non-conductive tube attached to a bottom of the second cylindrical screen or an extension of the second cylindrical conductive screen that is coated with the non-conductive material; and
a third non-conductive plate attached to a bottom of the first cylindrical non-conductive tube or a bottom of the extension of the first cylindrical conductive screen, a bottom of the second cylindrical non-conductive tube or a bottom of the extension of the second cylindrical conductive screen, wherein a third gap is formed between the third non-conductive plate and a bottom of the third cylindrical non-conductive tube.

12. The insertable plasma electrolysis apparatus as recited in claim 11, further comprising an opening disposed in the third non-conductive plate and connected to the first cylindrical tube.

13. The insertable plasma electrolysis apparatus as recited in claim 11, further comprising a non-conductive granular material disposed partially or completely within the first substantially equidistant gap and the second substantially equidistant gap.

14. The insertable plasma electrolysis apparatus as recited in claim 13, wherein the non-conductive granular material (a) does not pass through the first cylindrical conductive screen and the second cylindrical conductive screen, (b) allows an electrically conductive fluid to flow between the first cylindrical conductive screen and the second cylindrical conductive screen, and (c) prevents electrical arcing between the first and second cylindrical conductive.

15. The insertable plasma electrolysis apparatus as recited in claim 13, wherein the non-conductive granular material comprises marbles, ceramic beads, molecular sieve media, sand, limestone, activated carbon, zeolite, zirconium, alumina, rock salt, nut shell or wood chips.

16. A plasma electrolysis apparatus comprising:
a vessel;
a first non-conductive plate having a first outlet and a second outlet, wherein the first non-conductive plate is attached to a top of the vessel;
a first cylindrical conductive screen extending below the first non-conductive plate proximate to the first outlet such that a inner diameter of the first cylindrical conductive screen is greater than or equal to an inner diameter of the first outlet;
a cylindrical non-conductive tube extending below the first non-conductive plate such that the cylindrical non-conductive tube is disposed around the first cylindrical conductive screen with a first substantially equidistant gap between the first cylindrical conductive screen and the cylindrical non-conductive tube;
a second cylindrical conductive screen extending below the first non-conductive plate such that the second cylindrical conductive screen is disposed around the cylindrical non-conductive tube with a second substantially equidistant gap between the cylindrical non-conductive tube and the second cylindrical conductive screen;
the second outlet is either disposed between the cylindrical non-conductive tube and the second cylindrical conductive screen or outside of the second cylindrical conductive screen;
a first electrical terminal coupled to the first cylindrical conductive screen;
a second electrical terminal coupled to the second cylindrical conductive screen;
wherein a length of the first cylindrical conductive screen is less that a length of the second cylindrical conductive screen, and a length of the cylindrical non-conductive tube is greater than the length of the second cylindrical conductive screen;
a non-conductive granular material disposed partially or completely within vessel, the first substantially equidistant gap, and the second substantially equidistant gap;
a first vessel inlet or outlet disposed in a side of the vessel;
a second vessel inlet or outlet disposed in a bottom of the vessel or the side of the vessel proximate to the bottom of the vessel; and
one or more screens or filters disposed within or proximate to the first vessel inlet or outlet and the second vessel inlet or outlet, wherein the non-conductive granular material does not pass through the one or more screens or filters.

17. The plasma electrolysis apparatus as recited in claim 16, further comprising an electrically conductive fluid disposed within the vessel.

18. The plasma electrolysis apparatus as recited in claim 17, wherein the electrically conductive fluid comprises water, produced water, wastewater or tailings pond water.

19. The plasma electrolysis apparatus as recited in claim 17, wherein the electrically conductive fluid comprises a fluid containing an electrolyte.

20. The plasma electrolysis apparatus as recited in claim 19, wherein the electrolyte comprises baking soda, Nahcolite, lime, sodium chloride, ammonium sulfate, sodium sulfate or carbonic acid.

21. The plasma electrolysis apparatus as recited in claim 17, wherein an electrolysis is created whenever the first electrical terminal is connected to an electrical power supply such that the first electrically conductive screen has a first polarity, the second electrical terminal is connected to the electrical power supply such that the second electrically conductive screen has a second polarity, and the electrically conductive fluid is introduced into the first and second substantially equidistant gaps.

22. The plasma electrolysis apparatus as recited in claim 21, wherein hydrogen exits the first outlet and an oxidant outlet exits the second outlet.

23. The plasma electrolysis apparatus as recited in claim 21, wherein the first electrically conductive screen or the second electrically conductive screen reaches a temperature of at least 500° C., 1000° C., or 2000° C. during the electrolysis.

24. The plasma electrolysis apparatus as recited in claim 21, wherein once the electrolysis is created, the electrolysis is maintained without the electrically conductive fluid.

25. The plasma electrolysis apparatus as recited in claim 16, wherein the vessel comprises a pipe, conduit, column, tank, well or any structure that holds a fluid to form a closed system.

26. The plasma electrolysis apparatus as recited in claim 16, further comprising a power supply electrically coupled to the first cylindrical conductive screen and the second cylindrical conductive screen.

27. The plasma electrolysis apparatus as recited in claim 26, wherein the electrical power supply operates in a range from 50 to 500 volts DC, or 200 to 400 volts DC.

28. The plasma electrolysis apparatus as recited in claim 26, wherein first cylindrical conductive screen comprises a cathode and the second cylindrical conductive screen comprises and anode.

29. The plasma electrolysis apparatus as recited in claim 16, further comprising one or more sensors that monitor one or more parameters within the vessel.

30. The plasma electrolysis apparatus as recited in claim 16, further comprising:
an eductor having a first inlet, a second inlet and an outlet, wherein the outlet is coupled to the second vessel inlet or outlet;
a pump coupled to the first inlet of the eductor; and
a control valve coupled to the second inlet of the eductor.

31. The plasma electrolysis apparatus as recited in claim 16, further comprising an electrically conductive tube having a porous tip disposed within the first outlet and extending into the vessel beyond the length of the first cylindrical conductive screen.

32. The plasma electrolysis apparatus as recited in claim 31, wherein:
an electrolysis is created whenever the electrically conductive tube is connected to an electrical power supply such that the electrically conductive tube has a first polarity, the second electrical terminal is connected to the electrical power supply such that the second electrically conductive screen has a second polarity, and an electrically conductive fluid is introduced into the first and second substantially equidistant gaps; and
carbon monoxide exits the first output when carbon dioxide is introduced into the electrically conductive tube.
